(19) United States
(12) Patent Application Publication
(10) Pub. No.: US 2017/0204280 A1
(43) Pub. Date: Jul. 20, 2017

(54) CHROMATE-FREE PRECOATED METAL SHEET HAVING METALLIC APPEARANCE AND WATER-BASED COATING COMPOSITION USED IN THE SAME

(71) Applicant: NIPPON STEEL & SUMITOMO METAL CORPORATION, Tokyo (JP)

(72) Inventors: Atsushi MORISHITA, Tokyo (JP); Kimitaka HAYASHI, Tokyo (JP); Masahiro FUDA, Tokyo (JP); Yoshio KIMATA, Tokyo (JP); Kohei UEDA, Tokyo (JP); Kunihiko TOSHIN, Tokyo (JP); Yuusuke WADA, Tokyo (JP); Kouji OKUMURA, Tokyo (JP)

(73) Assignee: NIPPON STEEL & SUMITOMO METAL CORPORATION, Tokyo (JP)

(21) Appl. No.: 15/474,054

(22) Filed: Mar. 30, 2017

Related U.S. Application Data
(63) Continuation of application No. 14/353,544, filed on Apr. 23, 2014.

(30) Foreign Application Priority Data
Oct. 31, 2011 (JP) 2011-239362

(51) Int. Cl. C09D 7/12; C09D 167/02; C09D 5/36; C09D 133/00; C09D 5/08; C25D 3/56; C09D 175/04

(52) U.S. Cl. CPC C09D 7/1225; C25D 3/565; C09D 7/1283; C09D 167/02; C09D 175/04; C09D 133/00; C09D 5/08; C09D 5/36; C08K 9/10

(57) ABSTRACT

A chromate-free coated metal sheet according to the present invention includes: a metal sheet; and a coating film α which contains an organic resin A as a film formation component and a flaky aluminum pigment C having a deactivation-treated surface on at least one surface of the metal sheet; wherein the thickness of the coating film α is in a range of 1.5 to 10 μm.

This application is a continuation of co-pending U.S. patent application Ser. No. 14/353,544 filed on Apr. 23, 2014, which is the national phase of PCT International Application No. PCT/JP2012/066732 filed on Jun. 29, 2012, which claims the benefit of Japanese Patent Application No. 2011-239362 filed on Oct. 31, 2011. The entire contents of all of the above applications are hereby incorporated by reference.

### TECHNICAL FIELD OF THE INVENTION

The present invention relates to a chromate-free coated metal sheet which is excellent in design characteristics (luster and concealing properties), corrosion resistance, coating film adhesion (processing adhesion, water resisting adhesion), scratch resistance, chemical resistance and the like, and is cheap and which includes a coating film having a metallic appearance, containing no hexavalent chromium having a high environmental load on at least one side of a metal sheet, and to a water-based coating composition used to manufacture the chromate-free coated metal sheet.

### RELATED ART

Nowadays, there has been an increasing need for a high-grade metallic appearance in various fields such as home electric appliances.

In general, a metal sheet having a metallic appearance is used as an outer sheet in various products. As the outer sheet, high-quality materials, such as, stainless steel sheets, and aluminum sheets, are often used. However, these raw materials are expensive, and there is a strong demand for a more economical alternative.

A precoated metal sheet can be provided more inexpensively than a stainless steel sheet or an aluminum sheet. Therefore, in response to the circumstances above, there has been a demand for a precoated metal sheet with a metallic appearance.

In general, the coating film provided on the precoated metal sheet having a metallic appearance is formed as a three-layer structure which includes a primer coating film, an intermediate coating film, and an outer layer coating film applied in order on a metal sheet substrate side of a precoated metal sheet, or as a two-layer structure which includes a primer coating film and an outer layer coating film applied in order from a metal sheet substrate side of a precoated metal sheet. In either case, the outer layer coating film on the surface of the precoated metal sheet contains a pigment which provides a metallic appearance.

For example, Patent Document 1 discloses a metallic-looking matte design coated metal sheet including a coating layer with a three-layer structure. Specifically, the metallic-looking matte design coated metal sheet includes: a metal sheet having a surface which may be subjected to a chemical conversion (surface preparation), a primer coating film having a thickness after drying of 1 to 10 μm on the metal sheet, an intermediate coating film having a thickness after drying of 5 to 20 μm on the primer coating film, and an outer layer coating film having a thickness after drying of 10 to 25 μm which is formed by a metallic tone clear coating material on the intermediate coating film. The metallic tone clear coating material for forming the outer layer coating film contains aluminum pigments having an average particle diameter of 10 to 22 μm, and the aluminum pigments are preferably flaky.

Patent Document 2 discloses a white metallic coated metal sheet including a coating film having a two-layer structure. Specifically, in the white metallic coated metal sheet, a white under coat film including colorless or white rust preventive pigments, and a top coating film in which a metallic pigment is dispersed are formed on a metal sheet substrate, via a chemical conversion coating formed on the metal sheet substrate. Examples of the metallic pigment include aluminum flakes, pearly mica, metal-coated glass flakes, metal flakes, and sheet-like iron oxide. Patent Document 2 discloses that the thickness after drying of the under coating film and the top coating film is in a range of 5 to 30 μm.

As disclosed in Patent Documents 1 and 2, many upper coating films (top coating films) in the coated metal sheet (precoated metal sheet) having a metallic appearance contain aluminum flakes as a metallic pigment. As the metallic pigment, an aluminum pigment may be used by surface preparation.

For example. Patent Document 3 discloses a silica-coated aluminum pigment blended in a water-based coating material. Patent Document 3 discloses that when the silica-coated aluminum pigment is blended in a water-based coating material, gas is not generated by a reaction between aluminum and water, and that the storage ability thereof is excellent. In addition, it also discloses that when the silica-coated aluminum pigment is blended in a metallic coating material used to form a film required to have high voltage resistance, the high voltage resistance can be maintained without a decrease in the metallic appearance. Furthermore, it also discloses that when aluminum particles are used in a metallic coating material, they are preferably flaky (scaly) aluminum particles, and that the silica coating is preferably formed of silicon alkoxide.

Patent Document 4 discloses a water-based coating composition which can form a coating film having excellent corrosion resistance without containing a heavy metal on various kinds of metal substrates, such as steel plates, galvanized steel plates, and aluminum-plated steel plates, and a coated article which is obtained by coating a metal substrate with the water-based coating composition. The water-based coating composition contains an aluminum pigment with a surface which is treated so as to be deactive to water, as a component for improving corrosion resistance, in addition to a film formation component such as a water-based resin. Patent Document 4 also discloses that as the aluminum pigment, a flaky aluminum pigment is preferable, and that the aluminum pigment, the surface of which is subjected to a deactivation treatment in water, is densely positioned in the obtained coating film, prevents the permeation of corrosive substances, such as water, into the coating film, and thereby improves the corrosion resistance. The water-based coating composition in Patent Document 4 is preferably used as an undercoat or as a one coat finishing coating material, and when the water-based coating composition is used as a one coat finishing coating material, the thickness of the hardened coating film is generally in a range of about 8 μm to about 50 μm. It also discloses that the aluminum pigment is subjected to a surface preparation to prevent a reaction with water in a dispersion medium in the water-based coating composition, and a surface treatment agent used in the surface treatment is a copolymer having a phosphoric acid group which is obtained by copolymerizing a polymerizable unsaturated monomer having a phosphoric acid group, a polymerizable unsaturated monomer having a hydroxyl group, and another polymerizable unsaturated monomer which can copolymerize with the monomers or the like.

Patent Document 5 discloses a metallic coated steel sheet including a coating film having improved weather resistance and containing aluminum flakes as a metallic pigment. The aluminum flakes are coated with an acrylic resin to prevent direct contact between the aluminum flakes and a hindered amine light stabilizer (HALS) in a coating material or a coating film, and to inhibit a reaction therebetween after long term storage or after exposure to sunlight for a long period of time, and to thereby provide a precoated metal sheet having a metallic tone coating film which has excellent weather resistance and color stability.

It can be said that the precoated metal sheet is cheaper than the stainless steel sheet or the aluminum sheet. However, the precoated metal sheet is produced by coating the metal sheet substrate. Therefore, in order to satisfy the demands for cost reduction, it is necessary to decrease the number of layers in the coating film (ideally, to a one-layer coating film). Moreover, it is advantageous to reduce the thickness of the coating film as much as possible.

Patent Document 6 discloses a black coated metal sheet including a black coating film, which has a thickness of 2 to 10 μm and contains a specific polyester resin and carbon black, on at least one surface of a metal sheet. The black coating film can be formed on the surface of the metal sheet on which a surface preparation layer may be formed, without a primer layer.

In addition, Patent Document 7 discloses a colored steel sheet including a colored resin layer having a thickness of 5 μm or less.

Furthermore, Patent Document 8 discloses a colored steel sheet having a colored film on the surface of a steel sheet having specific relative roughness.

The coating film of the precoated metal sheet may be formed on a plated steel sheet of which the surface has been subjected to a chemical conversion (i.e., surface treatment). As the chemical conversion process, a chromating treatment has commonly been used. However, in consideration of environmental load of hexavalent chromium, which may be eluted from the chromate film, the demand for a non-chromium rust preventing treatment has recently been increasing.

For example, Patent Documents 9 and 10 disclose a non-chromium precoated steel sheet having excellent corrosion resistance, and the precoated steel sheet is already in practical use. The precoated steel sheet has a thick coating film having a thickness of 10 μm or more. The black coated metal sheet disclosed in Patent Document 6 is also a chromate-free coated metal sheet.

### PRIOR ART DOCUMENT

### Patent Document

[Patent Document 1] Japanese Unexamined Patent Application, First Publication No. 2009-297631

[Patent Document 2] Japanese Unexamined Patent Application, First Publication No. 2002-144474

[Patent Document 3] Japanese Unexamined Patent Application. First Publication No. 2004-124069

[Patent Document 4] Japanese Unexamined Patent Application, First Publication No. 2002-121470

[Patent Document 5] Japanese Unexamined Patent Application, First Publication No. 2007-237681

[Patent Document 6] PCT International Publication No. WO2010/137726 Pamphlet

[Patent Document 7] Japanese Unexamined Patent Application, First Publication No. H5-16292

[Patent Document 8] Japanese Unexamined Patent Application, First Publication No. H2-93093

[Patent Document 9] Japanese Unexamined Patent Application, First Publication No. 2000-199075

[Patent Document 10] Japanese Unexamined Patent Application, First Publication No. 2000-262967

### DISCLOSURE OF THE INVENTION

### Problems to be Solved by the Invention

As disclosed in Patent Documents 1 and 2, conventional precoated metal sheets having a metallic appearance mainly have a two-layer structure or a three-layer structure. In contrast, Patent Document 6 discloses a black coated material sheet including one coating film as a thin film (thickness is less than 10 μm) on at least one surface of a metal sheet, which is favorable to respond to the recent demands for coat reduction. However. Patent Document 6 never discloses a precoated metal sheet having metallic appearance. In addition, Patent Document 7 discloses a colored steel sheet including a colored resin layer having a thickness of 5 μm or less. Patent Document 8 discloses a colored steel sheet having a colored film on the surface of a steel sheet having a specific relative roughness. However, these Patent Documents never disclose a precoated metal sheet having a metallic appearance. In addition, the colored steel sheet disclosed in Patent Documents 7 and 8 is designed to secure corrosion resistance by forming a chromate film, and therefore is unable to meet the recent needs of a non-chromate treatment.

The object of the present invention is to provide a chromate-free precoated metal sheet which has a metallic appearance, can satisfy the recent demands for cost reduction, responds to the need for non-chromating process, and is extremely excellent in design characteristics (luster and concealing properties), corrosion resistance, coating film adhesion (processing adhesion, water resisting adhesion), scratch resistance, chemical resistance and the like, In addition, it is also an object of the present invention to provide a coating composition used to produce the chromate-free precoated metal sheet.

### Means for Solving the Problem

The gist of the present invention is shown below.

(1) A first aspect of the present invention is a chromate-free coated metal sheet including a metal sheet and a coating film α, which contains an organic resin A as a film formation component and a flaky aluminum pigment C having a deactivation-treated surface, on at least one surface of the metal sheet, wherein the thickness of the coating film α is in a range of 1.5 to 10 μm.
(2) In the chromate-free coated metal sheet according to (1), the coating film α may further contain silica particles D having an average particle diameter of 5 to 100 nm.
(3) In the chromate-free coated metal sheet according to (1) or (2), the amount of the aluminum pigment C in the coating film α may be in a range of 10 to 35% by mass.
(4) In the chromate-free coated metal sheet according to any one of (1) to (3), an average particle diameter of the aluminum pigment C may be in a range of 5 to 30 μm.
(5) In the chromate-free coated metal sheet according to any one of (1) to (4), a surface of the aluminum pigment C may be coated with a film containing at least one selected from the group consisting of a phosphoric acid compound, a molybdic acid compound, silica, and an acrylic resin.
(6) In the chromate-free coated metal sheet according to (5), the aluminum pigment C may be a silica film-coated aluminum pigment C_{Si}, a surface of which is coated with the silica film.
(7) in the chromate-free coated metal sheet according to (6), an amount of the silica film in the silica film-coated aluminum pigment C_{Si} relative to 100% by mass of aluminum may be in a range of 1 to 20% by mass in terms of Si.
(8) In the chromate-free coated metal sheet according to (6) or (7), a thickness of the silica film in the silica film-coated aluminum pigment C_{Si} may be in a range of 5 to 100 nm.
(9) In the chromate-free coated metal sheet according to any one of (1) to (8), the coating film α may further contain polyolefin resin particles E having an average particle diameter of 0.5 to 3 μm.
(10) In the chromate-free coated metal sheet according to (9), an amount of the polyolefin resin particles E in the coating film α may be in a range of 0.5 to 5% by mass.
(11) In the chromate-free coated metal sheet according to any one of (1) to (10), the organic resin A may be a resin cured by a curing agent B.
(12) In the chromate-free coated metal sheet according to any one of (1) to (11), the organic resin A may contain a polyester resin Ae having a sulfonic acid group in its structure.
(13) In the chromate-free coated metal sheet according to (12), the organic resin A may further contain a polyurethane resin Au having a carboxyl group and an urea group in its structure.
(14) In the chromate-free coated metal sheet according to any one of (1) to (13), a surface preparation layer β may be included under the coating film α.
(15) In the chromate-free coated metal sheet according to any one of (1) to (14), the metal sheet may be a zinc-base plated steel sheet.
(16) The second aspect of the present invention is a chromate-free coated metal sheet, wherein the coating film α in any one of (1) to (15) is formed by coating and drying by heat a water-based coating composition X containing constituent components of the coating film α on at least one surface of the metal sheet.
(17) The third aspect of the present invention is a water-based coating composition X including polyester resin particles Ae, which are made by a polyester resin having a sulfonic acid group in its structure, a flaky aluminum pigment C having a surface which is subjected to a deactivation treatment, and silica particles D having an average particle diameter of 5 to 100 nm.
(18) In the water-based coating composition X according to (17), the water-based coating composition X may further contain a polyurethane resin Au having a carboxyl group and an urea group in its structure.
(19) In the water-based coating composition X according to (17) or (18), the water-based coating composition X may further contain polyolefin resin particles E having an average particle diameter of 0.5 to 3 μm.
(20) In the water-based coating composition X according to any one of (17) to (19), the water-based coating composition X may further contain a curing agent B.

### Effects of the Invention

The chromate-free coated metal sheet having metallic appearance according to the present invention does not contain hexavalent chromium which has a large environmental impact, is cheap, and is extremely excellent in design characteristics (luster and concealing properties), corrosion resistance, coating film adhesion (processing adhesion, water resisting adhesion), scratch resistance, chemical resistance and the like. Therefore, the chromate-free coated metal sheet according to the present invention is promising as a metallic tone raw material which is cheap, is highly designable, adds value, is environmentally friendly, and significantly contributes to various industries.

### EMBODIMENTS OF THE INVENTION

In order to obtain a low-cost coated metal sheet having a metallic appearance, it is important to secure various performances including design characteristics (luster and concealing properties) by one coating film as thin as possible. Thereby, it is possible to reduce the cost of material needed to coat. In addition, in the case of a thin film, the coating film can be easily dried during coating, defects of the coating film, such as bubbles which are easily generated when a coating material is thickly coated, can also be prevented, and high productivity can be secured. In addition, a coating material used to form a coating film having metallic appearance is preferably a water-based coating material. Thereby, it is not necessary to use a special coating apparatus for production, and the costs associated with unnecessary coating processes can be reduced. For example, if a galvanized steel sheet is used as a substrate of the coated metal sheet, a water-based coating material can be coated in a coating process after a plating process in a line, that is, coating can be completed in a plating line. In contrast, if an organic solvent-based coating material is used, it is necessary to perform the coating in a special separate line for coating after plating.

In the coated metal sheet, in order to obtain a metallic appearance, it is essential to form a coating film containing a metallic pigment, such as an aluminum pigment. If an aluminum pigment in added to only one thin coating film having a thickness of 10 μm or less (that is, a coating film including a top coat layer without a primer layer), in order to secure design characteristics (concealing properties), a relatively large amount of a pigment should be added. In addition, since there is no primer layer, either the coating film is directly in contact with a metal sheet substrate, or when the metal sheet substrate is subjected to a surface treatment, only one extremely thin surface preparation layer is interposed between the coating film and the metal sheet substrate. Therefore, the contact probability between the aluminum pigment in the coating film and the surface of the metal sheet substrate is remarkably increased. Since aluminum is a metal, when aluminum is in contact with the surface of the metal sheet substrate, contact corrosion between dissimilar metals (galvanic corrosion) is caused, and the corrosion resistance of the coated metal sheet is damaged. For example, when the metal sheet substrate is a galvanized metal sheet, zinc on the surface of the metal sheet is corroded and white rust is generated. Furthermore, if a thin coating film having a high pigment concentration is used, corrosive substances, such as water, are able to easily permeate, and the aluminum pigment reacts with permeated water, and is oxidized. Due to this, the pigment becomes black, and design characteristics of the coated metal sheet is easily damaged.

As one countermeasure to prevent contact between the aluminum pigment and the surface of the metal sheet substrate and the reaction between the pigment and water from the outside, the present inventors have been examining coating the surface of the aluminum pigment. After the testing of various covering materials, it was found that coating (deactivation treatment) the surface of the aluminum pigment with a film containing at least one selected from the group consisting of a phosphoric acid compound, a molybdic acid compound, silica, and an acrylic resin is effective.

It is also found that flaky (scaly) aluminum pigment is advantageous as the aluminum pigment. Even for a thinner film, high design characteristics (concealing properties) can be secured by using the flaky aluminum pigment which is easily orientated in the coating film. It is also found that in a case of a flaky aluminum pigment, a thinner film would allow easy control of the orientation of the pigment, and that it is advantageous in obtaining a beautiful metallic appearance with a high degree of luster, and faults in appearance due to unevenness of orientation hardly occurs.

On the other hand, an organic resin is used as a film formation component of a coating material for a coating film. Thereby, coating film adhesion and high processability, which are required to the coated metal sheet, are secured. The organic resin is favorable for improving retention of the aluminum pigment in the coating film, and obtaining metallic appearance having durability.

In addition, it was found that the compatibility between the organic resin which is a film forming component and the aluminum pigment the surface of which is subjected to a coating treatment, is improved, that the entry of corrosive substances into the coating film is inhibited, and that the corrosion resistance can be improved by selecting a suitable organic resin and surface-coated aluminum pigment.

The present invention is achieved based on the knowledge above. Below, the embodiments of the present invention are explained in detail.

In the present invention having the object to provide a coated metal sheet including a coating film formed on a surface of a metal sheet as a low cost raw material which is replaced with a conventional metal sheet having a metallic appearance, such as a stainless steel sheet and an aluminum sheet, it is very important to form only one coating film as thin as possible on a surface of the metal sheet. In addition, it is necessary to add a relatively large amount of a metallic pigment to the coating film in order to obtain sufficient metallic tone using a single thin coating film. Even in the case of using a surface-treated metal sheet, only an extremely thin surface preparation layer is interposed between the coating film and the metal sheet substrate. When the two requirements above are satisfied, the contact probability between the metallic pigment in the coating film and the surface of the metal sheet substrate increases. Aluminum, which is used as a metallic pigment in the present invention, is metal. When metal aluminum is in contact with the surface of the metal sheet substrate, contact corrosion between dissimilar metals (galvanic corrosion) is caused, and the corrosion resistance of the coated metal sheet is damaged. In addition, corrosive substances, such as water, easily permeate into a thin coating film having a high pigment concentration, and then the aluminum pigment reacts with the permeated water, and is oxidized. Due to this, the pigment becomes black, and design characteristics of the coated metal sheet is easily damaged.

Therefore, the present inventors decided to use the aluminum pigment, the surface of which is subjected to a deactivation treatment by coating, in order to prevent the direct contact between the aluminum pigment used as a metallic pigment and the metal sheet substrate, and they examined favorable coating material for the aluminum pigment. The purpose of the coating is to prevent contact between the aluminum pigment and the metal sheet, and the contact between the aluminum pigment and the water permeated in the coating film. In order to achieve these objectives, the present inventors thought that a uniform film having no voids or the like is favorable. Therefore, in the first place, the present inventors tried to coat the aluminum pigment with a resin. As a result, the present inventors found that an aluminum pigment coated with an acrylic resin is favorable.

In order to use in various applications, it is preferable to use an aluminum pigment coated with a various materials. Therefore, an examination target was enlarged to an aluminum pigment coated with a material other than resins. As a result, it was found that a pigment, which is obtained by treating the aluminum pigment coated with resin and further with a phosphoric acid compound, is also favorable to achieve the object of the present invention. In addition, it was also found that a pigment, which is obtained by surface treating the aluminum pigment with a molybdic acid compound, and a pigment, which is obtained by surface treating the aluminum pigment with silica, are also favorable. Since the coating film containing a molybdic acid compound, a phosphoric acid compound, or silica can be considered to have ionic properties, it was unexpected that these materials would be useful to prevent the contact between the aluminum pigment and the metal sheet.

In this way, the present inventors obtained knowledge that coating the surface of the aluminum pigment with a film containing at least one selected from the group consisting of a phosphoric acid compound, a molybdic acid compound, silica, and an acrylic resin is advantageous, and achieved the completion of the present invention.

Next, the present invention is specifically explained.

In order to obtain a metallic appearance, a coating film, which is formed on at least one surface of a metal sheet, includes a flaky aluminum pigment of which the surface is subjected to a deactivation treatment by being coated on a chromate-free coated metal sheet according to the present invention. The surface coating of the aluminum pigment can be carried out by a film containing at least one selected from the group consisting of a phosphoric acid compound, a molybdic acid compound, silica, and an acrylic resin.

In order to express a metallic appearance by dispersing in a thin film, the aluminum pigment is preferably flaky (or scaly or platy). Here, “a flaky aluminum pigment” generally means an aluminum pigment having an aspect ratio (a ratio of an average particle diameter of D50 (particle diameter at which the accumulative weight reaches 50%/thickness) of 20 or more. The average particle diameter (D50 (particle diameter at which the accumulative weight reaches 50%)) of the favorable flaky aluminum used in the present invention is preferably in a range of 5 to 30 μm in order to express desired metallic appearance and from the ease of available. The average particle diameter (D50) is more preferably in the range of 10 to 25 μm. When the average particle diameter (D50) is less than 5 μm, the design characteristics (in particular, luster) may be deteriorated. In contrast, when it exceeds 30 μm, the design characteristics (concealing properties) may be deteriorated, and the corrosion resistance may also be deteriorated. The average particle diameter (D50) can be measured by using an aluminum pigment dispersant, which is obtained by uniformly mixing 0.5 g of an aluminum pigment paste, about 10 g of a solvent, such as toluene, with a magnetic stirrer or the like, and a laser diffraction/scattering type particle diameter measurement device (for example, Honeywell, “Microtrac HRA 9320X-100”). A preferred shape of the flaky aluminum in the coating film is explained in more detail. The average value of the diameter (when the shape is an oval shape or formless, and not a perfect circle, the average value of the long diameter and the short diameter) of the flat surface of the flaky aluminum is preferably in a range of 5 to 30 μm, and is more preferably in a range of 10 to 25 μm. When the diameter of the flat surface is less than 5 μm, the design characteristics (in particular, luster) may be deteriorated. In contrast, when the diameter exceeds 30 μm, the design characteristics (concealing properties) may be deteriorated and the corrosion resistance may be deteriorated. It is necessary to select the thickness of the flaky aluminum depending on the thickness of the film formed by the coating material containing the aluminum pigment. However, the thickness of the flaky aluminum is preferably in a range of 0.01 to 1 μm, and is more preferably in a range of 0.05 to 0.5 μm. It is technically difficult to control the thickness of the aluminum to less than 0.01 μm. When it exceeds 1.0 μm, the corrosion resistance may be deteriorated. The diameter of the flat surface can be measured by directly observing the surface of the coating film with a SEM (Scanning Electron Microscope). The thickness of the flaky aluminum can be measured by a method in which the coated metal sheet is embedded in a room-temperature curing type epoxy resin such that a vertical cross section can be observed, the surface of the embedded coated metal sheet is mechanically polished and the aluminum is observed with SEM (Scanning Electron Microscope) or a method in which an observation sample having a thickness in a range of 50 nm to 100 nm is cut such that a vertical cross section of the coating film can be observed from the coated metal sheet using FIB (Focusing Ion Beam) apparatus, and the section of the coating film is observed using TEM (Transmission Electron Microscope).

As the flaky aluminum pigment, a flaky aluminum pigment, which is produced by a ball-milling method, stamp-mill method, aluminum deposition and crushing method, or the like, is known. Any one flaky aluminum pigment can be used as long as the objects of the present invention can be achieved. In addition, a marketed flaky aluminum pigment can also be used.

The flaky aluminum pigment is coated with a film containing at least one of a phosphoric acid compound, a molybdic acid compound, silica, and an acrylic resin.

For example, as disclosed in Japanese Unexamined Patent Application, First Publication No. 2003-82259, the aluminum pigment coated with a phosphoric acid compound film can be obtained by treating the aluminum pigment dispersed in a dispersion medium with diammonium hydrogen phosphate. Besides diammonium hydrogen phosphate, examples of a phosphoric acid used in the coating treatment include ammonium dihydrogen phosphate, aluminum phosphate monobasic, orthophosphoric acid, pyrophosphoric acid, metaphosphoric acid, triphosphoric acid, tetraphosphoric acid, phosphorous acid, polyphosphoric acid, lauryl phosphoric acid, polyoxypropylene olcyl ether phosphate, dipolyoxyethylene nonyl phenyl ether phosphate, acid organic phosphoric ester, and acid organic phosphorous ester. The coating amount of the phosphoric acid compound film relative to 100% by mass of aluminum is preferably in a range of 0.1 to 3.0% by mass in terms of P. When the coating amount is less than 0.1% by mass, the effects obtained by coating are insufficient. In contrast, when it exceeds 3.0% by mass, the design characteristics (luster and metal texture) may be deteriorated. The more preferred coating amount of the phosphoric acid compound film is in a range of 0.2 to 2.0% by mass. As the aluminum pigment coated with the phosphoric acid compound film, marketed products can also be used.

For example, as disclosed in Japanese Unexamined Patent Application, First Publication No. H6-57171, the aluminum pigment coated with a molybdic acid compound film can be obtained by treating the aluminum pigment dispersed in a dispersion medium with ammonium paramolybdate. Besides ammonium paramolybdate, examples of a molybdic acid compound used in the coating treatment include metal salts of molybdic acid (magnesium salt, calcium salt, strontium salt, and barium salt), molybdenum dithiophosphate, and molybdenum dithiocarbamate. The coating amount of the molybdic acid compound film relative to 100% by mass of aluminum is preferably in a range of 0.1 to 10% by mass in terms of Mo. When the coating amount is less than 0.1% by mass, the effects obtained by coating are insufficient. In contrast, when it exceeds 10% by mass, design characteristics (luster and metal texture) may be deteriorated. The more preferred coating amount of the molybdic acid compound film is in a range of 1 to 8% by mass. As the aluminum pigment coated with the molybdic acid compound film, marketed products can also be used.

For example, as disclosed in Japanese Unexamined Patent Application, First Publication No. 2004-124069, the aluminum pigment coated with a silica film can be obtained by treating the aluminum pigment dispersed in a dispersion medium with alkoxysilane, such as tetraethoxysilane. Besides tetraethoxysilane, examples of a silane source used in the coating treatment include alkoxy silanes, such as tetramethoxysilane, tetra-n-propoxysilane, tetraisopropoxysilane, and tetra-n-butoxysilane, and silane coupling agents. The coating amount of the silica film relative to 100% by mass of aluminum is preferably in a range of 1.0 to 20% V by mass in terms of Si. When the coating amount is less than 1.0% by mass, the effects obtained by coating are insufficient. In contrast, when it exceeds 20% by mass, design characteristics (luster and metal texture) may be deteriorated. The more preferred coating amount of the silica film is in a range of 3.5 to 10% by mass. The thickness of the coated silica film is preferably in a range of 5 to 100 nm. When the thickness is less than 5 nm, the effects obtained by coating are insufficient. In contrast, when it exceeds 100 nm, design characteristics (luster and metal texture) may be deteriorated. The preferred thickness of the coated silica film is in a range of 15 to 50 nm. As the aluminum pigment coated with the silica film, marketed products can also be used.

For example, as disclosed in Japanese Unexamined Patent Application. First Publication No. 2005-146111, the aluminum pigment coated with an acrylic resin film can be obtained by adding trimethylol propane triacrylate, acrylic acid, and azobisisobutyronitrile in a dispersion of the aluminum pigment, and reacting them. In this way, the aluminum pigment coated with the acrylic resin film can be obtained by polymerizing at least one acrylic monomer by a polymerization initiator in the dispersion containing the aluminum pigment. Examples of the acrylic monomer include alkyl (meth)acrylates, such as methyl acrylate, ethyl acrylate, butyl acrylate, 2-ethylhexyl acrylate, benzyl acrylate, phenoxyethyl acrylate, methyl methacrylate, ethyl methacrylate, butyl methacrylate, 2-ethylhexyl methacrylate, and benzyl methacrylate; a carboxyl group-containing unsaturated monomers, such as acrylic acid, methacylic acid, propylacrylic acid, isopropylacrylic acid, crotonic acid, maleic anhydride, and phthalic acid; two or more reactive functional groups-containing polymerizable unsaturated monomers, such as tetramethylolmethane tetraacrylate, tetramethylolmethane triacrylate, trimethylolpropane triacrylate, trimethylolpropane trimethacrylate, and divinyl benzene; phosphoric acid group-containing polymerizable unsaturated monomers, such as (2-acryloyloxyethyl) acid phosphate, (2-acryloyloxypropyl) acid phosphate. (2-methacryloyloxyethyl) acid phosphate, and (2-methacryloyloxypropyl) acid phosphate; styrene, and acrylonitrile. Examples of the polymerization initiator include azo compounds, such as azobisisobutyronitrile, and organic peroxide, such as benzoyl peroxide. The coating amount of the acrylic resin film relative to 100% by mass of aluminum is preferably in a range of 5 to 25% by mass. When the coating amount is less than 5% by mass, the effects obtained by coating are insufficient. In contrast, when it exceeds 25% by mass, design characteristics (luster and metal texture) may be deteriorated. The more preferred coating amount of the acrylic resin film is in a range of 8 to 20% by mass. As the aluminum pigment coated with the acrylic resin film, marketed products can also be used.

The aluminum pigment coated with the acrylic resin film can be further treated with phosphate. For example, as disclosed in Japanese Unexamined Patent Application, First Publication No. 2002-121423, the treatment can be carried out by adding the phosphoric acid compound as explained above in a dispersion containing the aluminum pigment coated with the acrylic resin film which is obtained as explained above. Each coating amount of the acrylic resin film and the phosphoric acid compound film is the same as the above. In this case, as the aluminum pigment coated with the acrylic resin film, marketed products can also be used.

As the flaky aluminum pigment of which the surface is subjected to the deactivation treatment explained above, the flaky aluminum pigment coated with the silica film is particularly preferable in the present invention.

It is preferable that 10 to 35% by mass of the flaky aluminum pigment of which the surface is subjected to the deactivation treatment be contained in the coating film of the chromate-free coated metal sheet according to the present invention. When the amount of the flaky aluminum pigment is less than 10% by mass, desired design characteristics (luster and concealing properties) may not be obtained. In contrast, when it exceeds 35% by mass, the corrosion resistance and water resisting adhesion may be deteriorated. The preferred amount of the flaky aluminum pigment is in a range of 15 to 30% by mass.

For example, as disclosed in Patent Documents 3, 4, and 5, the aluminum pigment which is subjected to a surface coating treatment has been known. However, it has been unknown that the surface-coated aluminum pigment is used to prevent the increase of the probability of the contact corrosion between dissimilar metals which is caused by adding the aluminum pigment in a single coating film of the coated metal sheet and easily contacting the surface-coated aluminum pigment with the surface of the metal sheet substrate. The aluminum pigment coated with the silica film disclosed in Patent Document 3 is used to prevent the generation of gas due to the reaction between aluminum and water in a water-based coating material and thereby improve storage stability of the coating material and obtain sufficient voltage resistance without damaging metal texture. Patent Document 4 discloses that the aluminum pigment, which is subjected to a surface treatment to deactivate against water, is densely positioned in the coating film formed by the coating composition, prevents the permeation of corrosive substances, such as water in a coating film, and thereby corrosion resistance is improved. Patent Document 5 discloses that the aluminum pigment coated with the acrylic resin film is not in direct contact with a hindered amine light stabilizer (HALS) in the coating film containing HALS, and thereby storage of the coating material for a long period of time, weather resistance, and color stability can be improved.

The aluminum pigment which is subjected to the surface coating treatment used in the present invention not only prevents the contact corrosion between dissimilar metal caused by contacting with the surface of the metal sheet substrate but is also useful at preventing the generation of dangerous hydrogen gas due to the reaction between the aluminum pigment and water in the coating material when the coating material used to form the coating film is a water-based coating material.

In the coating film of the coated metal sheet according to the present invention, silica particles having an average particle diameter of 5 to 100 nm may be added in addition to the flaky surface-coated aluminum pigment. Such fine silica particles are dispersed in the coating film, prevent the contact between the aluminum pigment and the surface of the metal sheet substrate, and therefore, are favorable in preventing the contact corrosion between dissimilar metals. In addition, the silica particles are favorable to beautifully show the coated metal sheet having a metallic appearance without decreasing burnish of the coating film. Furthermore, the silica particles contribute to improve corrosion resistance and scratch resistance of the coated metal sheet.

There is no particular limitation on the silica particles, and colloidal silica, fumed silica, and the like can be used. In addition, marketed silica particles can also be used. Examples of the marketed silica particles include SNOWTEX® O, SNOWTEX® N. SNOWTEX® C, and SNOWTEX® IPA-ST (Nissan Chemical Industries, Ltd.), adelite AT-20N, and AT-20A (Adeka Corporation), and AEROSIL® 200 (Nippon Aerosil Co., Ltd.).

The amount of the silica particles in the coating film is preferably in a range of 3 to 25% by mass. When the amount is less than 3% by mass, the sufficient expected effects cannot be obtained. When it exceeds 25% by mass, the coating film adhesion of the coated metal sheet may be decreased. The amount of the silica particles in the coating film is more preferably in a range of 5 to 20% by mass.

The organic resin which is a film formation component in the coating film of the coated metal sheet according to the present invention preferably contains a polyester resin as a base component in order to obtain various properties, such as corrosion resistance, coating film adhesion (processing adhesion and water resisting adhesion), scratch resistance, and chemical resistance of the coating film in well balance. In addition, the organic resin containing a polyester resin as a base component which is baked and cured using a curing agent is more preferable. In other words, the processing adhesion can be obtained by using a polyester resin having high ductility, high processing properties, and adhesion. In addition, the coating film having corrosion resistance, water resisting adhesion, scratch resistance and chemical resistance can be obtained by baking and curing the organic resin containing a polyester resin as a base component using a curing agent. The degradation of film formation ability due to addition of the aluminum pigment can be compensated by baking and curing using a curing agent. The coating film, which is dense and has excellent balance between ductility and hardness, can be obtained. The polyester resin preferably has a sulfonic acid group. The sulfonic acid group in the polyester resin has effects of improving compatibility to the aluminum pigment and barrier properties to corrosive substances and the like as well as effects of improving the adhesion to the metal sheet which is a substrate (when the substrate is subjected to a surface treatment, the surface preparation layer). That is, the sulfonic acid group in the polyester resin has the effect of further improving the coating film adhesion and corrosion resistance.

As explained above, the coating film having metallic appearance containing the polyester resin having a sulfonic acid group, which is cured by a curing agent, and the surface-coated aluminum pigment is excellent in design characteristics (luster, and concealing properties), corrosion resistance, scratch resistance, chemical resistance and the like. In addition, the coating film is extremely excellent in adhesion to a metal sheet substrate or the surface preparation layer. Therefore, it is possible to provide the chromate-free coated metal sheet which is excellent in coating film adhesion (processing adhesion and water resisting adhesion) of the coating film without using a chromate film which becomes a harmful hexavalent chromium source.

The coated metal sheet having the coating film according to the present invention shows high-quality metallic appearance. In addition, it is found that when the coated metal sheet is subjected to a bending processing or an overhanging processing, the luster is increased as the processed part. This is an advantage which cannot be obtained from a post coating which coats a coated object shaped by processing in advance. In addition, the color tone of the coated metal sheet having metallic tone according to the present invention is similar to the color tone of the metal sheet substrate. Therefore, the coated metal sheet according to the present invention has characteristics in which scratches are less conspicuous compared with a black coated metal sheet, for example.

The thickness of the coating film in the coated metal sheet according to the present invention is preferably in a range of 1.5 to 10 μm. When the thickness is less than 1.5 μm, sufficient design characteristics (luster, and concealing properties) and corrosion resistance cannot be obtained. In contrast, when the thickness exceeds 10 μm, it is not only economically disadvantageous but cracks are also easily generated in the coating film, defects in the coating film, such as bubbles, are easily generated when a coating material thickly coated, and the appearance needed as industrial goods cannot be stably obtained. The thickness of the coating film is more preferably 2 to 10 μm, and most preferably in a range of 3 to 7 μm.

The thickness of the coating film can be measured by observing the cross section of the coating film or using an electromagnetic film thickness meter. In addition, it is possible to calculate the thickness by dividing the mass of the coating film adhered to a unit area by the specific gravity after drying of the coating film or the specific gravity after drying of the coating material. The adhesion mass of the coating material can be obtained by using an existing method, such as a method using the measured difference in mass of the coating material before and after coating, or the measured difference in mass of the coating film before and after peeling; a method in which the known existing amount of an element of which the content in the coating film is known is measured by fluorescence X-ray analyzing the coating film, and the like. The specific gravity after drying of the coating film or the coating material can be obtained using an existing method, such as a method in which the volume and mass of the peeled coating film are measured; a method in which an adequate amount of the coating material is transferred in a vessel, the coating material is dried, and the volume and mass of the dried coating material are measured; a method based on the amount and the known specific gravity of the components of the coating film; and the like.

Among these measuring methods, since the measurement is easily and precisely carried out even on coating films having different specific gravities or the like, it is preferable to observe the cross section of the coating film as the measurement method of the coating film.

There is no particular limitation on the observation method of the coating film. However, examples of the method include a method in which the coated plated steel sheet is embedded in a room-temperature curing type epoxy resin such that a vertical cross section can be observed, the surface of the embedded coated plated steel sheet is mechanically polished and the surface is observed with SEM (Scanning Electron Microscope) or a method in which an observation sample having a thickness of 50 nm to 100 nm is cut such that a vertical cross section of the coating film can be observed from the coated metal sheet using FIB (Focusing Ion Beam) apparatus, and the cross section of the coating film is observed using SEM (Scanning Electron Microscope) or TEM (Transmission Electron Microscope).

For example, a polyester resin having a sulfonic acid group which is preferably used as a film formation component in the coating film can be obtained by dissolving or dispersing a product which is obtained by condensation polymerization of an polyester raw material containing a polycarboxylic acid component and a polyol component.

There is no particular limitation on the carboxylic acid component. However, examples of the carboxylic acid component include terephthalic acid, isophthalic acid, orthophthalic acid, 2,6-naphtalene dicarboxylic acid, succinic acid, glutaric acid, adipic acid, sebacic acid, dodecane dicarboxylic acid, azelaic acid, 1,2-cyclohexane dicarboxylic acid, 1,3-cyclohexane dicarboxylic acid, 1,4-cyclohexane dicarboxylic acid, dimer acid, trimellitic anhydride, and pyromellitic anhydride. The carboxylic acid component can be used alone or in combination of two or more.

There is no particular limitation on the polyol component. However, examples of the polyol component include ethylene glycol, diethylene glycol, 1,3-propanediol, 1,2-propanediol, triethylene glycol, 2-methyl-1,3-propanediol 2,2-dimethyl-1,3-propanediol, 2-butyl-2-ethyl-1,3-propanediol, 1,4-butanediol, 2-methyl-1,4-butanediol, 2-methyl-3-methyl-1,4-butanediol, 1,5-pentanediol, 3-methyl-1,5-pentanediol, 1,6-hexanediol, 1,4-cyclohexanedimethanol, 1,3-cyclohexanedimethanol, 1,2-cyclohexanedimethanol, hydrogenated bisphenol A, dimerdiol, trimethylol ethane, trimethylol propane, glycerin, and pentaerythritol. The polyol component can be used alone or in combination of two or more.

There is no particular limitation on a method for introducing a sulfonic acid group. However, examples of the method for introducing a sulfonic acid group include a method of using dicarboxylic acid, such as 5-sulfoisophthalic acid, 4-sulfonaphthalene-2,7-dicarboxylic acid, and 5-(4-sulfophenoxy)isophthalic acid or glycol, such as 2-sulfo-1,4-butanediol, and 2,5-dimethyl-3-sulfo-2,5-hexyldiol, as a polyester raw material.

The amount of the dicarboxylic acid having a sulfonic acid group or glycol having a sulfonic acid group used is preferably in a range of 0.1 to 10% by mol relative to the total amount of the polycarboxylic acid component or polyol component. When the amount is less than 0.1% by mol, the solubility or dispersibility thereof in water is deteriorated, the dispersibility of the aluminum pigment is deteriorated, and the thin coating film above may not have an acceptable design characteristics (luster, and concealing properties). In contrast, when the amount of dicarboxylic acid exceeds 10% by mol, the corrosion resistance of the coated metal sheet may be deteriorated. From the viewpoint of the balance between design characteristics (luster, and concealing properties) and the corrosion resistance in thin coating film, the amount is more preferably in a range of 0.5 to 5% by mol.

The sulfonic acid group contained in the polyester resin is a functional group denoted by —SO₃H. The sulfonic acid group may be neutralized by alkali metal, amine containing ammonia, or the like. When the sulfonic acid group is neutralized, the sulfonic acid group which is already neutralized may be introduced in a resin, or neutralizing the sulfonic acid group after introducing in a resin. In particular, a metal sulfonate group is neutralized by an alkali metal, such as Li. Na, or K, has high hydrophilicity, and improves the dispersibility of the aluminum pigment, so a metal sulfonate group is preferable in order to obtain high design characteristics. In addition, in order to improve the adhesion of the substrate of the coating film, the sulfonic acid group is preferably a metal sulfonate group which is neutralized by an alkali metal, and most preferably a sodium sulfonate group.

The hydroxyl value of the polyester resin is preferably in a range of 2 to 30 mgKOH/g. When the hydroxyl value is less than 2 mgKOH/g, baking and curing using a curing agent is insufficient, and corrosion resistance, scratch resistance, and chemical resistance may be deteriorated. In contrast, when it exceeds 30 mgKOH/g, baking and curing is carried out excessively, and corrosion resistance, and coating film adhesion may be deteriorated. The hydroxyl value can be measured by dissolving polyester resin in a solvent, reacting the polyester resin and acetic anhydride, and back titrating the excess amount of acetic anhydride with potassium hydroxide.

The glass transition temperature of the polyester resin is preferably in a range of 5 to 50° C. When the glass transition is less than 5° C., the scratch resistance, and chemical resistance may be deteriorated. In contrast, when it exceeds 50° C., the coating film adhesion may be deteriorated. From the viewpoint of both of the chemical resistance and coating film adhesion, the glass transition temperature of the polyester resin is more preferably in a range of 5 to 25° C. The glass transition temperature can be measured by using a scanning colorimeter.

The number average molecular weight of the polyester resin is preferably in a range of 8,000 to 25,000. When the number average molecular weight is less than 8,000, the coating film adhesion and chemical resistance of the coating film may be deteriorated. In contrast, when it exceeds 25,000, the storage stability of the coating material may be deteriorated (the coating material may be solidified or a setting may be generated with time). The number average molecular weight can be measured in terms of polystyrene by gel permeation chromatography.

There is no particular limitation on the curing agent used to cure the polyester resin. For example, a melamine resin or a polyisocyanate compound can be used. The melamine resin is a resin which is obtained by etherifying a part or all of a methylol group of a product, which is obtained by condensing melamine and formaldehyde, with low alcohol, such as methanol, ethanol, and butanol. There is no particular limitation on the polyisocyanate compound. Examples of the polyisocyanate compound include hexamethylene diisocyanate, isophorone diisocyanate, xylene diisocyanate, and tolylene diisocyanate. In addition, a block product of the polyisocyanate compound, such as a block product of hexamethylene diisocyanate, a block product of isophorone diisocyanate, a block product of xylene diisocyanate, a block product of tolylene diisocyanate, and the like can also be used. These curing agents can be used alone or in combination of two or more.

The amount of the curing agent used is preferably in the range of 5 to 35% by mass relative to 100% by mass of the total organic resin (when the coating film of the coated metal sheet contains an organic resin in addition to the polyester resin, the total organic resin includes the organic resin in addition to the polyester resin). When the amount used is less than 5% by mass, baking and curing is insufficient, and the corrosion resistance, scratch resistance, and chemical resistance may be deteriorated. In contrast, when it exceeds 35% by mass, baking and curing is carried out excessively, and corrosion resistance, and coating film adhesion may be deteriorated.

From the viewpoint of the corrosion resistance, scratch resistance, chemical resistance, the curing agent preferably contains a melamine resin. The amount of the melamine resin in the curing agent is preferably in a range of 30 to 100% by mass. When the amount is less than 30% by mass, the corrosion resistance, scratch resistance, and chemical resistance may be insufficient.

The organic resin, which is a film formation component, in the coating film of the coated metal sheet according to the present invention more preferably contains a polyurethane resin having a carboxyl group and an urea group in its structure in addition to the polyester resin having a sulfonic acid group in its structure. The cohesion of the coating film is further improved by adding the polyurethane resin having an urea group which has high cohesive energy. Thereby, the corrosion resistance, water resisting adhesion, and scratch resistance of the coated metal sheet can be further improved. In addition, the adhesion to the metal sheet (when the metal sheet is subjected to a surface treatment, the surface preparation layer) as well as the storage stability of the coating material are further improved by introducing a carboxyl group in the polyurethane resin.

Examples of the polyurethane resin having an urea group in its structure include polyurethane which is obtained by

an urethanation reaction in the presence of excess isocyanate group in the diisocyanate compound between any one of polyetherpolyols (such as ethylene glycol, propylene glycol, diethylene glycol, 1,6-hexanediol, neopentyl glycol, triethylene glycol, glycerin, trimethylol ethane, trimethylol propane, polycarbonate polyol, polyester polyol, and bisphenol hydroxypropyl ether), and polyvalent alcohol (such as polyesteramide polyol, acrylic polyol, polyurethane polyol, and a mixture thereof), and any one of a diisocyanate compound, for example, aliphatic diisocyanate (such as hexamethylene diisocyanate (HDI)), alicyclic diisocyanate (such as isophorone diisocyanate (IPDI)), aromatic diisocyanate (such as tolylene diisocyanate (TDI)), aromatic-aliphatic diisocyanate (such as diphenylmethane diisocyanate (MDI)), and a mixture thereof to obtain a urethane prepolymer,

chain-extension of the obtained urethane polymer with diamine, for example, any one of aliphatic polyamine (such as ethylene diamine, propylene diamine, hexamethylene diamine, diethylene triamine, dipropylene triamine, triethylene tetramine, and tetraethylene pentamine), aromatic polyamine (such as tolylene diamine, xylylene diamine, and diaminophenyl methane), alicyclic polyamine (such as diaminocyclohexyl methane, piperazine, 2,5-dimethyl piperazine, and isophorone diamine), hydrazine (such as hydrazine, succinic dihydrazide, adipic dihydrazide, and phthalic dihydrazide), and alkanol amine (such as hydroxyethyl diethylene triamine, 2-[(2-aminoethyl)amino]ethanol, and 3-aminopropanediol), and

dispersing in water.

The molecular weight of the resin can be increased by chain-extending with the diamine, and the urea group is produced by the reaction between the isocyanate group and the amino group.

There is no particular limitation on the method of introducing a carboxyl group in the polyurethane resin. Examples of the method of introducing a carboxyl group in the polyurethane resin include a method in which at least one of:

carboxyl group-containing compounds which are obtained by reacting an active hydrogen group-containing compound and derivatives thereof with a carboxyl group-containing compound (such as 2,2-dimethylol propionic acid, 2,2-dimethylol butyric acid, 2,2-dimethylol valeric acid, dioxy maleic acid, 2,6-dioxy benzoic acid, and 3,4-diamino benzoic acid), and a derivative thereof,

polyester polyols which are obtained by copolymerizing one or more among of the carboxyl group-containing compounds above.

anhydride group-containing compounds, such as maleic anhydride, phthalic anhydride, succinic anhydride, trimellitic anhydride, and pyromellitic anhydride, and

polyester polyols, which are obtained by copolymerizing one or more among the carboxyl group-containing compounds obtained by the reaction, the polyester polyols, and anhydride group-containing compounds above

is copolymerized during the production of the urethane prepolymer.

The amount of the polyurethane resin having an urea group in its structure is preferably in a range of 5 to 100% by mass relative to 100% by mass of the polyester resin. When the amount is less than 5% by mass, the corrosion resistance, water resisting adhesion, and scratch resistance may not be improved. In contrast, when it exceeds 100% by mass, the chemical resistance and processing adhesion may be deteriorated.

The coating film of the coated metal sheet according to the present invention preferably further contains polyolefin resin particles. The polyolefin resin particles functions as a lubricant component, and improve the scratch resistance of the coated metal sheet.

There is no particular limitation on the polyolefin resin particles. Examples of the polyolefin resin particles include particles made from hydrocarbon-based wax, such as paraffin, microcrystalline, and polyethylene, and derivatives thereof. Among these, the polyolefin resin particles are preferably polyethylene resin particles. There is no particular limitation on the derivatives. Examples of the derivative include carboxylated polyolefin and chlorinated polyolefin. These compounds can be used alone or in combination of two or more.

The average particle diameter and amount used of the polyolefin resin particles are preferably adjusted so as not to disfigure the metallic appearance of the coated metal sheet. When the effects to the corrosion resistance and scratch resistance are concerned, the average particle diameter of the polyolefin resin particles is preferably in a range of 0.5 to 3 μm. The amount of the polyolefin resin particles in the coating film is preferably in a range of 0.5 to 5% by mass. When the amount of the polyolefin resin particles is less than 0.5% by mass, the scratch resistance may not be improved. In contrast, when it exceeds 5% by mass, the design characteristics (luster) and corrosion resistance may be deteriorated.

The coating film of the coated metal sheet according to the present invention contains a surface-coated flaky aluminum pigment (which can include “particles” in a broad sense), and if necessary, both or either of the silica particles and the polyolefin resin particles.

In general, it is very difficult to specify the shape or size of particles in the thin coating film. However, it can be considered that the particulate components contained in the coating film can maintain the same shape or size as that of the particulate components in the coating material (a solution or dispersion containing components used to form a coating film) as long as the particulate component is not affected by any physical or chemical changes (for example, bonding or cohesion of the particulate components, significant dissolution in the solvent of the coating material, or reaction with other components) in the production process of the coating film. The surface-coated aluminum pigment, silica particles, and polyolefin resin particles, which are the particulate components used in the present invention, are selected such that they do not significantly dissolve in the solvent of the coating material used to form the coating film, and react with the solvent or other components of the coating film. In addition, in order to maintain the existence form of the particulate components in the coating material, if necessary, it is possible to use a dispersion, in which the particulate components are dispersed in a water-based solvent by a well-known surfactant or dispersant, such as a water-soluble resin, as a raw material of the coating material. Therefore, the particle diameter of the particulate components contained in the coating film, which is specified in the present invention, can be represented by the particle diameter of them in the coating material used to form the coating film.

Specifically, the particle diameter of relatively fine particles, such as the silica particles, used in the present invention can be measured by a dynamic light scattering method (nano tracker method). According to the dynamic light scattering method, the particle diameter of fine particles in a dispersion medium, of which the temperature, viscosity, and refractive index are known, is easily found. Since the particulate components used in the present invention are selected such that they do not significantly dissolve in the solvent of the coating material used to form the coating film, and react with the solvent or other components of the coating film, the particle diameter in a specific dispersion medium is measured, and the measured particle diameter can be used as the particle diameter of the particulate components in the coating material. In the dynamic light scattering method, laser light irradiates fine particles dispersed in a dispersion medium under Brownian movement, scattering light from the fine particles are measured, the autocorrelation function is calculated, and the particle diameter is calculated by the cumulant method. As a particle diameter measuring device with the dynamic light scattering method, for example, FPAR-1000, marketed by Otsuka Electronics Co., ltd., can be used. In the present invention, a cumulant average particle diameter of the particles in a dispersion sample containing the particles to be measured at 25° C. is measured five times, and the average value of five times is used as the average particle diameter. The measurement of an average particle diameter by the dynamic light scattering method is disclosed, for example, in Journal of Chemical Physics, Vol. 57, No. 11 (December, 1972) page 4814.

On the other hand, a median diameter (D50) in the accumulated distribution measured by the laser diffraction-scattering method (Microtrac method) can be used as a particle diameter of relative large particles, such as the flaky aluminum pigment and polyolefin resin particles used in the present invention. The laser diffraction-scattering method uses the fact that the quantity and pattern of scattered light obtained by irradiating light to particles varies depending on the particle diameter, and is widely used to measure particle diameter in a range of submicron to several millimeters. Since the particulate components used in the present invention are selected such that they do not significantly dissolve in the solvent of the coating material used to form the coating film, and react with the solvent or other components of the coating film, the particle diameter, which is measured as explained, can be used as a particle diameter of the particulate components in the coating material. For example, Microtrac particle size analyzer marketed by Nikkiso Co., Ltd. can be used in the laser diffraction-scattering method. In the present invention, an average value of five times is used as the average particle diameter of the particles.

In addition, it is also possible to directly measure the shape or the particle diameter of the particulate component (the flaky aluminum pigment, silica particles, and polyolefin resin particles) in the coating film by observing the coating film from the cross section. There is no particular limitation on the observation method of the cross section of the coating film. However, a method in which the coated metal sheet is embedded in a room-temperature curing type epoxy resin such that a vertical cross section can be observed, the surface of the embedded coated metal sheet is mechanically polished and the cross section is observed with a SEM (Scanning Electron Microscope) or a method in which an observation sample having a thickness of 50 nm to 100 nm is cut such that a vertical cross section of the coating film can be observed from the coated metal sheet using FIB (Focusing Ion Beam) apparatus, and the section of the coating film is observed using a TEM (Transmission Electron Microscope) can be used.

The coated metal sheet according to the present invention preferably includes a surface preparation layer under the coating film, that is, between the coating film and the metal sheet substrate. There is no particular limitation on the surface preparation layer. However, it is possible to further improve the adhesion between the coating film and the metal sheet substrate and the corrosion resistance by forming a surface preparation layer containing at least one selected from the group consisting of a silane coupling agent, an organic resin, and a polyphenol compound. In addition, it is also possible to further improve the adhesion between the coating film and the metal sheet substrate and the corrosion resistance by forming a surface preparation layer containing all of a silane coupling agent, an organic resin, and a polyphenol compound.

There is no particular limitation on the silane coupling agent used in the surface preparation layer. Examples of the silane coupling agent include vinyl trimethoxysilane, vinyl triethoxysilane, γ-aminopropyl trimethoxysilane, γ-aminopropyl ethoxysilane. N-[2-(vinyl benzyl amino)ethyl]-3-aminopropyl trimethoxysilane, γ-methacryloxypropyl methyl dimethoxysilane, γ-methacryloxypropyl trimethoxysilane, γ-methacryloxypropyl methyl diethoxysilane. γ-methacryloxypropyl triethoxysilane, 7-glycidoxypropyl triethoxysilane. γ-glycidoxypropyl methyl diethoxysilane, 7-glycidoxypropyl trimethoxysilane, 2-(3,4-epoxycyclohexyl)ethyl trimethoxysilane. N-β-(aminoethyl)-γ-aminopropyl trimethoxysilane, N-β-(aminoethyl)-γ-aminopropyl triethoxysilane. N-β-(aminoethyl)-γ-aminopropyl methyl dimethoxysilane, N-phenyl-γ-aminopropyl trimethoxysilane, and γ-mercaptopropyl trimethoxysilane, which are marketed by Shin-Etsu Chemical Co., Ltd., Dow Corning Toray Co., Ltd., Chisso Corporation. Momentive Performance Materials Inc. or the like. These silane coupling agent can be used alone or in combination of two or more.

There is no particular limitation on the organic resin used in the surface preparation layer. Examples of the organic resin include well-known organic resins, such as a polyester resin, polyurethane resin, epoxy resin, phenol resin, acrylic resin, and polyolefin resin. In order to improve the adhesion to the metal sheet substrate, it is preferable to use at least one selected from the group consisting of a polyester resin, polyurethane resin, epoxy resin, and phenol resin. In order to improve the compatibility to polyester resin contained in the coating film, and to improve the adhesion, the surface preparation layer preferably contains a polyester resin.

The polyphenol compound used in the surface preparation layer means a compound having two or more of phenolic hydroxyl groups bonded with a benzene ring, or condensates thereof. Examples of the compound having two or more of phenolic hydroxyl groups bonded with a benzene ring include gallic acid, pyrogallol, and catechol. There is no particular limitation of the condensate of the compound having two or more of phenolic hydroxyl groups bonded with a benzene ring. Examples of the compound include polyphenol compounds which are commonly called as “tannic acid” and widely distributed in vegetable world.

Tannic acid is a general term of aromatic compounds having a complicated structure having many phenolic hydroxyl groups which are widely distributed in vegetable world. The tannic acid may be a hydrolyzable tannic acid, or condensation type tannic acid. There is no particular limitation on tannic acid. Examples of the tannic acid include hamameli tannin, persimmon tannin, tea tannin, sumac tannin, gallnut tannin, myrobaran tannin, divi-divi tannin, algarovilla tannin, valonia tannin, and catechin tannin. As the tannic acid, commercially available ones, for example, “Tannic Acid Extract A”, “B Tannic Acid”, “N Tannic Acid”, “Industrial Tannic Acid”. “Purified Tannic Acid”, “High Tannic Acid”, “F Tannic Acid”, “Local Tannic Acid” (all made by Dainippon Pharma. Co., Ltd.), “Tannic Acid AL” (Fuji Chemical Industry Co., Ltd.), and so on may be used.

These polyphenol compounds may be used alone or in combination of two or more.

The amount of at least one selected from the group consisting of the silane coupling agent, an organic resin, and a polyphenol compound which are contained in the surface preparation layer is not particularly limited, but preferably 10% by mass or more in 100% by mass of the surface preparation layer. When the amount is less than 10% by mass, the adhesion or corrosion resistance may not be improved.

In addition, the surface preparation layer more preferably contains at least one selected from the group consisting of a phosphoric acid compound, a fluorine-containing complex compound and a vanadium (IV)-containing compound to improve the corrosion resistance.

There is no particular limitation on the phosphoric acid compound. Examples of the phosphoric acid compound include phosphoric acid, ammonium salt of phosphoric acid, alkali metal salt of phosphoric acid, and alkali earth metal salt of phosphoric acid. There is no particular limitation on the fluorine-containing complex compound. Examples of the fluorine-containing complex compound include hexafluorotitanic acid, hexafluorozirconic acid, ammonium salt thereof, and alkali metal salt thereof. There is no particular limitation on the vanadium (IV)-containing compound. Examples of the vanadium (IV)-containing compound include vanadium (IV)-containing compounds which are obtained by reducing vanadium (V) in vanadium pentoxide (V₂O₅), methavanadic acid (HVO₃), ammonium methavanadate (NH₄VO₃), sodium methavanadate (NaVO₃), vanadium oxytrichloride (VOCl₃) or the like using a reducing agent, such as alcohol and or organic acid, vanadium (IV)-containing compounds, such as vanadium dioxide (VO₂), vanadium oxyacetyl acetonate (VO(C₅H₇O₂)₂), and vanadium oxysulfate (VOSO₄), and vanadium (IV)-containing compounds which are obtained by oxidizing vanadium (III) in vanadium acetyl acetonate (V(C₅H₇O₂)₂), vanadium trioxide (V₂O₃), vanadium trichloride (VCl₃), or the like using an oxidizing agent.

There is no particular limitation on the adhesion amount of the surface preparation layer. However, the adhesion amount of the surface preparation layer is preferably in a range of 10 to 1,000 mg/m². When the adhesion amount is less than 10 mg/m², sufficient effects of the surface preparation layer cannot be obtained. In contrast, when it exceeds 1,000 mg/m², the surface preparation layer may be easily aggregated and disrupted. From the viewpoint of stable effects and economy, the adhesion amount of the surface preparation layer is more preferably in a range of 50 to 700 mg/m².

There is no particular limitation on the metal sheet used in the present invention. Examples of the metal sheet include an iron sheet, iron-based alloy sheet, cupper sheet, and copper-based alloy sheet. In addition, a plated-metal sheet, which is obtained by plating on an arbitrary metal sheet, can also be used. The present invention prevents the contact corrosion between the aluminum pigment and metal dissimilar to the aluminum. In principle, the contact corrosion between dissimilar metals can be generated when an electric potential difference exists between two metals which are in contact with each other. Therefore, even when the surface of the metal sheet substrate is made of aluminum, there is any difference in metallic structure or surface conditions between the aluminum pigment and aluminum on the surface of the metal sheet substrate, which causes an electric potential difference between them, the contact corrosion between dissimilar metals is generated. Therefore, examples of the metal sheet used in the present invention include an aluminum sheet, an aluminum-based alloy sheet, and an aluminum-based plated sheet.

In the present invention, the metal sheet is most preferably a zinc-base plated steel sheet. Examples of the zinc-base plated steel sheet include a galvanized steel sheet, a zinc-nickel plated steel sheet, a zinc-iron plated steel sheet, a zinc-chromium plated steel sheet, a zinc-aluminum plated steel sheet, a zinc-titanium plated steel sheet, a zinc-magnesium plated steel sheet, a zinc-manganese plated steel sheet, a zinc-aluminum-magnesium plated steel sheet, and a zinc-aluminum-magnesium-silicon plated steel sheet; a steel sheet in which a small amount of different types of metal elements or impurities, such as cobalt, molybdenum, tungsten, nickel, titanium, chromium, aluminum, manganese, iron, magnesium, lead, bismuth, antimony, tin, copper, cadmium, and arsenic, is contained in the plated layer of the steel sheet above; and steel sheets in which inorganic substance, such as silica, alumina, and titania; is dispersed in the plated layer of the steel sheet above.

Furthermore, the invention can also use a multilayer plating sheet which combines the plated layer above and another plated layer, such as an iron plated layer, an iron-phosphorus plated layer, a nickel plated layer, and a cobalt plated layer. There is no particular limitation on the plating method. Any well-known method, such as well-known electroplating, hot dipping, evaporation plating, dispersal plating, and vacuum plating, can be used.

The chromate-free coated metal sheet having metallic appearance according to the present invention can be produced by coating a coating material used to make a coating film on at least one surface of the metal sheet substrate which is subjected to a surface preparation if necessary, baking and drying, and thereby forming a coating film.

There is no particular limitation on the preparation method of a coating material for a coating film, that is, a composition including the solvent, the organic resin, and the surface-coated aluminum pigment, which are coating film-formation components, and further another component if necessary. Examples of the preparation method include a method in which coating film-formation components are added in a water-based solvent, the mixture is stirred with a Disper, and thereby the coating film-formation components are dissolved or dispersed in the water-based solvent. In order to improve solubility or dispersibility of the coating film-formation components, if necessary, a well-known hydrophilic solvent or the like can be added. Here. “water-based solvent” means a solvent containing water as a main component. The amount of water in the solvent is preferably 50% by mass or more. Solvent other than water may be an organic solvent. However, the solvent is more preferably not an organic solvent mixture (containing an organic solvent of more than 5% by weight, which is listed in the appended Table 6-2 of ordinance on prevention of organic solvent poisoning in industrial safety and health law). It is not necessary for the metal sheet to pass through a line for coating an organic solvent-based coating material in surplus by using a water-based solvent. Therefore, the production cost is remarkably reduced. In addition, this has environmental benefits, such as remarkable reduction of discharge of a volatile organic compound (VOC).

There is no particular limitation on the coating method of the coating material to the metal sheet substrate. Examples of the coating method include roll coating, curtain flow coating, air-spray, airless spray, dipping, bar coating, and brush coating.

There is no particular limitation on baking and drying method for the coating material. The metal sheet may be dried by heating in advance, heating after coating, or both thereof. There is no particular limitation of the heating method. Hot air, induction heating, near infrared rays, direct heating, etc. can be used alone or in combination. The highest temperature for baking and drying is preferably in a range of 150 to 250° C. When the highest temperature is less than 150° C., the curing by baking is insufficient, and the moisture resistance, corrosion resistance, scratch resistance, and chemical resistance may be deteriorated. In contrast, when it exceeds 250° C. the curing by baking becomes excessive, and the corrosion resistance and workability may be deteriorated. The highest temperature is more preferably in a range of 160 to 230° C., and most preferably in a range of 180 to 220° C. The time for baking and drying is preferably in a range of 1 to 60 seconds. When the time for baking and drying is less than 1 second, curing by baking is insufficient, and the moisture resistance, corrosion resistance, scratch resistance, and chemical resistance may be deteriorated. In contrast, when it exceeds 60 seconds, productivity may be deteriorated. The time for baking and drying is more preferably in a range of 3 to 20 seconds.

There is no particular limitation on the production method for the surface preparation layer. Examples of the production method for the surface preparation layer include a method in which a coating material used to form the surface preparation layer is coated on at least one surface of the metal sheet, and heated to dry. There is no particular limitation of the method for coating the coating material. Examples of the coating method include well-known coating methods, such as roll coating, spray coating, bar coating, dipping, and electrostatic coating. There is also no particular limitation on the baking and drying method. The metal sheet may be dried by heating in advance, after coating, or both of them. There is no particular limitation of the heating method. Hot air, induction heating, near infrared rays, direct heating, and so on can be used alone or in combination. The highest temperature for baking and drying is preferably in a range of 60 to 150° C. When the highest temperature is less than 60° C., the drying is insufficient, and adhesion to the substrate and corrosion resistance may be deteriorated. In contrast, when it exceeds 150° C. the adhesion to the substrate may be deteriorated. The highest temperature is more preferably in a range of 70 to 130° C.

### EXAMPLES

Below, Examples of the present invention will be explained. However, the present invention is not limited to these Examples.

### (1) Metal Sheet

The types of the metal sheets used are shown in Table 1. As a substrate of plated metal sheet, a soft steel sheet having a thickness of 0.5 mm was used. The SUS sheet was a ferritic stainless steel sheet (steel composition: C: 0.008% by mass. Si: 0.07% by mass, Mn: 0.15% by mass, P: 0.011% by mass, S: 0.009% by mass, Al: 0.067% by mass, Cr: 17.3% by mass, Mo: 1.51% by mass, N: 0.0051% by mass, Ti: 0.22% by mass, and a balance of Fe and unavoidable impurities) was used. The metal sheet was used after the surface of the metal sheet was alkali degreased, washed with water and dried.

TABLE 1

| No. | Metal sheet (thickness: 0.5 mm, plated both sides) |
|---|---|
| M1 | Electrogalvanized steel sheet (plating deposition amount: |
| | 20 g/m²) |
| M2 | Hot dip galvanized steel sheet (plating deposition amount: |
| | 60 g/m²) |
| M3 | Galvannealed steel sheet (Fe: 10%, plating deposition amount: |
| | 45 g/m²) |
| M4 | Electro Zn—10% Ni alloy plated steel sheet (plating deposition |
| | amount: 20 g/m²) |
| M5 | Hot dip Zn—11% Al—3% Mg—0.2% Si plated steel sheet (plating |
| | deposition amount: 60 g/m²) |
| M6 | Hot dip Zn—55% Al—1.6% Si plated steel sheet (plating |
| | deposition amount: 75 g/m²) |
| M7 | Hot dip Al—9% Si plated steel sheet (plating deposition amount: |
| | 40 g/m²) |
| M8 | SUS sheet (ferritic stainless steel sheet) |

### (2) Surface Preparation Layer

A coating material used to form a surface preparation layer was prepared by blending an organic resin (Table 2), a silane coupling agent (Table 3), a polyphenol compound (Table 4), silica particles (Table 5), a phosphoric acid compound (Table 6), a fluoro-containing complex compound (Table 7), a vanadium (IV)-containing compound (Table 8) so as to be a composition ratio (% by mass in terms of a solid component) shown in Table 9, and stirred using a stirrer for a coating material. Then, as necessary, a surface preparation layer was formed by coating the mixture on the surface of the metal sheet prepared in (1) above such that the adhesion amount was 100 mg/m², and dried under conditions in which the highest temperature was 70° C.

TABLE 2

| No. | Organic resin |
|---|---|
| a1 | Polyester resin (Toyobo Co., Ltd.; VYLONAL ® MD-1200) |
| a2 | Epoxy resin (Asahi Denka Kogyo; Adeka Resin EM0436FS-12) |
| a3 | Phenol Resin (Sumitomo Bakelite; PR-NPK-261) |
| a4 | Polyurethane resin (Dai-ichi KogyoSeiyaku Co., Ltd; |
| | SUPERFLEX ® 620) |

TABLE 3

| No. | Silane coupling agent |
|---|---|
| b1 | 3-glycidoxypropyl trimethoxysilane |
| b2 | 3-aminopropyl triethoxysilane |

TABLE 4

| No. | Polyphenol compound |
|---|---|
| c1 | Tannic acid (Fuji Chemical Industry; Tannic Acid AL) |

TABLE 5

| No. | Silica particles |
|---|---|
| d1 | Colloidal silica |
| | (Nissan Chemical Industries, Ltd.; SNOWTEX ® N; |
| | particle diameter: 15 nm) |
| d2 | Colloidal silica |
| | (Nissan Chemical Industries, Ltd.; SNOWTEX ® C; |
| | particle diameter: 15 nm) |

TABLE 6

| No. | Phosphoric acid compound |
|---|---|
| e1 | Phosphoric acid |
| e2 | Magnesium biphosphate |

TABLE 7

| No. | Fluoro-containing complex compound |
|---|---|
| f1 | Hexafluorotitanic acid |
| f2 | Hexafluorozirconic acid |

TABLE 8

| No. | Vanadium (IV)-containing compound |
|---|---|
| g1 | Vanadium oxysulfate |
| g2 | Vanadium oxyacetyl acetonate |

TABLE 9

| | Surface preparation layer (β) | | | | | | | | | |
|---|---|---|---|---|---|---|---|---|---|---|
| | Organic resin | | Silane coupling agent | | Other components | | | | | |
| | | Amount | | Amount | | Amount | | Amount | | Amount |
| No. | Type | (%) | Type | (%) | Type | (%) | Type | (%) | Type | (%) |
| β1 | a1 | 60 | b1 | 40 | | | | | | |
| β2 | a2 | 60 | b1 | 40 | | | | | | |
| β3 | a3 | 60 | b1 | 40 | | | | | | |
| β4 | a4 | 60 | b1 | 40 | | | | | | |
| β5 | a1 | 50 | b1 | 30 | c1 | 20 | | | | |
| β6 | a1 | 40 | b1 | 20 | c1 | 20 | d1 | 20 | | |
| β7 | a1 | 40 | b1 | 20 | c1 | 20 | d2 | 20 | | |
| β8 | a1 | 38 | b1 | 20 | c1 | 20 | d2 | 20 | e1 | 2 |
| β9 | a4 | 60 | b1 + b2 | 20 + 20 | | | | | | |
| β10 | a4 | 56 | b1 + b2 | 17 + 17 | e1 | 10 | | | | |
| β11 | a4 | 56 | b1 + b2 | 17 + 17 | e2 | 10 | | | | |
| β12 | a4 | 53 | b1 + b2 | 16 + 16 | e1 | 10 | f1 | 5 | | |
| β13 | a2 | 53 | b1 + b2 | 16 + 16 | e1 | 10 | f2 | | | |
| β14 | a3 | 53 | b1 + b2 | 16 + 16 | e1 | 10 | f2 | 5 | | |
| β15 | a4 | 53 | b1 + b2 | 16 + 16 | e1 | 10 | f2 | | | |
| β16 | a4 | 52 | b1 + b2 | 15 + 15 | e1 | 10 | f2 | 5 | g1 | 3 |
| β17 | a4 | 52 | b1 + b2 | 15 + 15 | e1 | 10 | f2 | 5 | g2 | 3 |

### (3) Coating Film Layer

A coating composition used to form a coating film was prepared by blending an organic resin A (as explained in Production Examples 1 to 3 of Organic Resin in (3-1) below and Table 10), a curing agent B (Table 11), an aluminum pigment C (as explained in Aluminum Pigment Production Examples 1 to 13 in (3-2) below and Table 12), silica particles D (Table 13), and polyolefin resin particles E (Table 14) so as to be a composition ratio (% by mass in terms of a solid component) shown in Table 15, and stirred using a stirrer for a coating material. Then, a coating film was formed by coating the mixture on the surface of the surface preparation layer formed in (2) above (when the surface preparation layer was not formed, on the surface of the metal sheet prepared in (1) Metal sheet above) so as to have a fixed thickness with a roll coater, and heated and dried by heating to a fixed highest temperature.

### (3-1) Production Example of Organic Resin A

### <Production Example 1 for Organic Resin>

In a reaction vessel provided with a stirrer, a condenser, and a thermometer, 199 parts of terephthalic acid, 232 parts of isophthalic acid, 199 parts of adipic acid, 33 parts of 5-sodium sulfoisophthalate, 312 parts of ethylene glycol, 125 parts of 2,2-dimethyl-1,3-propanediol, 187 parts of 1,5-pentanediol, and 0.41 parts of tetrabutyl titanate were added, and an esterification reaction was proceeded from 160° C. to 230° C. for 4 hours. Then, the pressure inside the reaction system was gradually reduced to 5 mmHg for 20 minutes, and a polymerization reaction was proceeded in vacuum of 0.3 mmHg or less at 260° C. for 40 minutes. In 100 parts of the obtained copolymerized polyester resin, 20 parts of butyl cellosolve, and 42 parts of methyl ethyl ketone were added, the mixture was dissolved by stirring at 80° C. for 2 hours, 213 g of deionized water was added, and dispersed in water. After that, the solvent was distilled by heating, and filtrated with 200-mesh membrane made of nylon. Thereby, an aqueous polyester resin dispersion A1 having a solid concentration of 30% was obtained.

### <Production Example 2 for Organic Resin>

In a reaction vessel provided with a stirrer, a condenser, and a thermometer, 199 parts of terephthalic acid, 266 parts of isophthalic acid, 199 parts of adipic acid, 312 parts of ethylene glycol, 125 parts of 2,2-dimethyl-1,3-propanediol, 187 parts of 1,5-pentanediol, and 0.41 parts of tetrabutyl titanate were added, and an esterification reaction was proceeded from 160° C. to 230° C. for 4 hours. Then, the pressure inside the reaction system was gradually reduced to 5 mmHg for 20 minutes, and a polymerization reaction was proceeded in vacuum of 0.3 mmHg or less at 260° C. for 40 minutes. The mixture was cooled to 220° C. under nitrogen gaseous stream, 23 parts of trimellitic anhydride and 16 parts of ethylene glycol bisanhydrotrimellitate were added, and reacted for 30 minutes. In 100 parts of the obtained copolymerized polyester resin, 20 parts of butyl cellosolve, and 42 parts of methyl ethyl ketone were added, the mixture was dissolved by stirring at 80° C. for 2 hours, 23 parts of isopropyl alcohol and 3.5 parts of triethylamine were added, then 213 g of deionized water was added, and dispersed in water. After that, the solvent was distilled by heating, and filtrated with a 200-mesh membrane made of nylon. Thereby, an aqueous polyester resin dispersion A2 having a solid concentration of 30% was obtained.

### <Production Example 3 for Organic Resin>

230 parts of polyester polyol, which was synthesized by adipic acid having a hydroxyl group at the end and 1,4-butylene glycol, and had an average molecular weight of 900, and 15 parts of 2,2-bis(hydroxymethyl) propionic acid were added to 100 parts of N-methyl-2-pyrrolidone, and the mixture was heated to 80° C. to dissolve. After 100 parts of hexamethylene diisocyanate was added, the mixture was heated to 110° C. reacted for 2 hours, and then 11 parts of triethylamine was added to neutralize. The obtained solution was dropped in an aqueous solution containing 5 parts of ethylenediamine and 570 parts of deionized water while stirring strongly. Thereby, an aqueous polyester resin dispersion A3 having a solid concentration of 30% was obtained.

### (3-2) Production Example of Aluminum Pigment C

### <Production Example 1 of Aluminum Pigment>

An aluminum paste (Showa Aluminum Powder K.K.; Sap FM4010 (aluminum content: 67% by mass: D₅₀: 11 μm: thickness: 0.2 μm)) was weighed such that the aluminum content was 300 g, 4.300 g of propylene glycol monomethyl ether, 1.000 g of deionized water, and 188 g of 25% by mass-ammonia water were added, the mixture was stirred in a 10 L-reaction vessel provided with a stirrer, a cooling pipe, and a dropping funnel. Then, a mixture, which was obtained by diluting a certain amount of tetraethoxysilane with propylene glycol monomethyl ether, was gradually dropped by the dropping funnel. After the completion of the reaction, the reaction solution was filtrated, the obtained filter cake was washed with propylene glycol monomethyl ether, and propylene glycol monomethyl ether was added in the washed filter cake. Thereby, a silica film-coated aluminum pigment paste C1 having a solid content of 50% by mass was obtained. The coated amount of the silica film relative to 100% by mass of aluminum was 1% by mass in terms of Si, and the thickness of the silica film was 5 nm.

### <Production Example 2 of Aluminum Pigment>

A silica film-coated aluminum pigment pastes C2 to C5 having different coated amount and thickness of the silica film from those of the aluminum pigment having a solid content of 50% by mass in Production Example 1 were obtained in a manner identical to that of the Production Example 1 of Aluminum Pigment except that the coated amount and the thickness of the silica film were changed by adjusting the dropping amount of the mixture which was obtained by diluting tetraethoxysilane with propylene glycol monomethyl ether. The coated amount of the silica film relative to 100% by mass of aluminum was, in terms of Si, 3.5% by mass in the paste C2, 7% by mass in the paste C3, 10% by mass in the paste C4, and 20% by mass in the paste C5. The thickness of the silica film was 18 nm in the paste C2, 35 nm in the paste C3, 50 nm in the paste C4, and 100 nm in the paste C5.

### <Production Example 3 of Aluminum Pigment>

An aluminum paste (Showa Aluminum Powder K.K.; Sap 616FP (aluminum content: 70% by mass: D₅₀: 18 μm: thickness: 0.3 μm)) was weighed such that the aluminum content was 300 g, 2,000 g of mineral spirit was added, the mixture was stirred in a 5 L-reaction vessel provided with a stirrer, a cooling pipe, and a dropping funnel. Then, 36.9 g of trimethylolpropane acrylate (TMP), 0.34 g of acrylic acid (AA), and 1.34 g of azobisisobutyronitrile were mixed. The obtained mixture was dropped through the dropping funnel in the 5 L-reaction vessel under heated conditions. After that, the mixture was stirred at 90° C. for 2 hours, and the reaction was completed. Then, the reaction solution was filtrated, the obtained filter cake was washed with mineral spirit, and further with propylene glycol, and propylene glycol was added in the washed filter cake. Thereby, an acrylic resin film-coated aluminum pigment paste C6 having a solid content of 50% by mass was obtained. The coated amount of the acrylic resin film relative to 100% by mass of aluminum was 12% by mass.

### <Production Example 4 of Aluminum Pigment>

An aluminum paste (Showa Aluminum Powder K.K.; Sap 561PS (aluminum content: 67% by mass; D₅₀: 16 μm; thickness: 0.2 μm)) was weighed such that the aluminum content was 300 g, 1,500 g of propylene glycol monomethyl ether was added, the mixture was stirred in a 5 L-reaction vessel provided with a stirrer, a cooling pipe, and a dropping funnel. Then, an aqueous solution, which was obtained by dissolving a certain amount of ammonium paramolybdate in 300 g of deionized water, was gradually dropped by the dropping funnel, and the reaction was carried out in pH 8 to 9, at room temperature for 1 hour. After the completion of the reaction, the reaction solution was filtrated, the obtained filter cake was washed with deionized water, and further with propylene glycol monomethyl ether. Then, propylene glycol monomethyl ether was added in the washed filter cake. Thereby, a molybdic acid film-coated aluminum pigment paste C7 having a solid content of 50% by mass was obtained. The coated amount of the silica film relative to 100% by mass of aluminum was 2.5% by mass in terms of Mo.

### <Production Example 5 of Aluminum Pigment>

An aluminum paste (Showa Aluminum Powder K.K.; Sap 561PS (aluminum content: 67% by mass: D₅₀: 16 μm; thickness: 0.2 μm)) was weighed such that the aluminum content was 300 g, 1.200 g of propylene glycol monomethyl ether was added, the mixture was stirred in a 5 L-reaction vessel provided with a stirrer, a cooling pipe, and a dropping funnel. Then, an aqueous solution, which was obtained by dissolving a certain amount of ammonium dihydrogen phosphate in 300 g of deionized water, was gradually dropped by the dropping funnel, heated to 70° C., and the reaction was carried out for 5 hours. After the completion of the reaction, the reaction solution was filtrated, the obtained filter cake was washed with deionized water, and further with propylene glycol monomethyl ether. Then, propylene glycol monomethyl ether was added in the washed filter cake. Thereby, a phosphoric acid film-coated aluminum pigment paste C8 having a solid content of 50% by mass was obtained. The coated amount of the phosphoric acid film relative to 100%/o by mass of aluminum was 1.0% by mass in terms of P.

### <Production Example 6 of Aluminum Pigment>

An aluminum paste (Showa Aluminum Powder K.K.; Sap FM4010 (aluminum content: 40% by mass; acrylic resin film-coated aluminum particles; the coated amount of the acrylic resin film is 9% by mass relative to 100% by mass of aluminum; D₅₀: 1 μm; thickness: 0.2 μm)) was weighed such that the aluminum content was 300 g, mineral spirit contained in the aluminum paste was displaced with propylene glycol, and the mixture was stirred in a 5 L-reaction vessel provided with a stirrer, a cooling pipe, and a dropping funnel. Then, an aqueous solution, which was obtained by dissolving a certain amount of ammonium dihydrogen phosphate in 300 g of deionized water, was gradually dropped by the dropping funnel, heated to 70° C., and the reaction was carried out for 5 hours. After the completion of the reaction, the reaction solution was filtrated, the obtained filter cake was washed with deionized water, and further with propylene glycol monomethyl ether. Then, propylene glycol monomethyl ether was added in the washed filter cake. Thereby, a phosphoric acid film-coated aluminum pigment paste C9 having a solid content of 50% by mass was obtained. The coated amount of the phosphoric acid film relative to 100% by mass of aluminum was 1.0% by mass in terms of P.

### <Production Example 7 of Aluminum Pigment>

A silica film-coated aluminum pigment paste C10 having a solid content of 50% by mass was obtained using an aluminum paste (Showa Aluminum Powder K.K.; Sap 2173SW (aluminum content: 69% by mass; D₅₀: 6 μm; thickness: 0.1 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica-coated aluminum pigment paste C10 relative to 100% by mass of aluminum was 7% by mass in terms of Si. The thickness of the silica film was 35 nm.

### <Production Example 8 of Aluminum Pigment>

A silica film-coated aluminum pigment paste C11 having a solid content of 50% by mass was obtained using an aluminum paste (Showa Aluminum Powder K.K.; Sap CS430 (aluminum content: 70% by mass: D₅₀: 9 μm: thickness: 0.3 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica film-coated aluminum pigment paste C11 relative to 100% by mass of aluminum was 7% by mass in terms of Si. The thickness of the silica film was 35 nm.

### <Production Example 9 of Aluminum Pigment>

A silica film-coated aluminum pigment paste C12 having a solid content of 50% by mass was obtained using an aluminum paste (Showa Aluminum Powder K.K.; Sap 561PS (aluminum content: 67% by mass; D₅₀: 16 μm; thickness: 0.2 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica film-coated aluminum pigment paste C12 relative to 100% by mass of aluminum was 3.5% by mass in terms of Si. The thickness of the silica film was 18 nm.

### <Production Example 10 of Aluminum Pigment>

A silica film-coated aluminum pigment paste C13 having a solid content of 50% by mass was obtained using an aluminum paste (Showa Aluminum Powder K.K.; Sap 576PS (aluminum content: 75% by mass; D₅₀: 20 μm; thickness: 0.4 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica-coated aluminum pigment paste C13 relative to 100% by mass of aluminum was 3.5% by mass in terms of Si. The thickness of the silica film was 18 nm.

### <Production Example 11 of Aluminum Pigment>

A silica-coated aluminum pigment paste C14 having a solid content of 50% by mass was obtained using an aluminum paste (Showa Aluminum Powder K.K.; Sap LB584 (aluminum content: 76% by mass; D₅₀: 25 μm; thickness: 0.4 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica film-coated aluminum pigment paste C14 relative to 100% by mass of aluminum was 3.5% by mass in terms of Si. The thickness of the silica film was 18 nm.

<Production Example 12 of Aluminum Pigment>

A silica film-coated aluminum pigment paste C15 having a solid content of 50% by mass was obtained using an aluminum paste (Showa Aluminum Powder K.K.; Sap 720N (aluminum content: 78% by mass; D₅₀: 30 μm; thickness: 0.6 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica film-coated aluminum pigment paste C15 relative to 100% by mass of aluminum was 3.5% by mass in terms of Si. The thickness of the silica film was 18 nm.

### <Production Example 13 of Aluminum Pigment>

A silica film-coated aluminum pigment paste C16 having a solid content of 50% by mass was obtained using an aluminum paste (Showa Aluminum Powder K.K.; Sap LB588 (aluminum content: 77% by mass; D₅₀: 36 μm; thickness: 0.6 μm)) in a manner identical to that of the Production Example 1 of Aluminum Pigment by adjusting the dropping amount of the mixture which was obtained by diluting tetraethoxysilane with propylene glycol monomethyl ether. The coated amount of the silica film in the silica film-coated aluminum pigment paste C16 relative to 100% by mass of aluminum was 3.5% by mass in terms of Si. The thickness of the silica film was 18 nm.

TABLE 10

| No. | Organic resin (A) |
|---|---|
| A1 | Polyester resin having a Na sulfonate group (Production Example |
| | 1) |
| A2 | Polyester resin having a carboxyl group (Production Example 2) |
| A3 | Polyurethane resin having an urea group and a carboxyl group |
| | (Production Example 3) |
| A4 | Polyurethane resin having a cationic functional group (Dai-ichi |
| | KogyoSeiyaku Co., Ltd; SUPERFLEX ® 620) |
| A5 | Acrylic resin (Nippon NSC Ltd. Kanevinol AD121) |
| A6 | Polyolefin resin (TOHO Chemical Industry C., Ltd. HYTEC |
| | S-3121) |

TABLE 11

| No. | Curing agent (B) |
|---|---|
| B1 | Melamine resin |
| | (Nihon Cytec Industries Inc., Cymel 303) |
| B2 | Melamine resin |
| | (Nihon Cytec Industries Inc., Cymel 325) |
| B3 | Isocyanate compound |
| | (Mitsui Chemicals, Inc., TAKENATE ®WD-725) |

TABLE 12

| No. | Aluminum pigment (C) |
|---|---|
| C1 | Silica film-coated aluminum pigment |
| | (Preparation Example 1, Particle diameter: 11 μm, |
| | Coated amount of the silica film: 1% by mass in terms of Si, |
| | Thickness of the silica film: 5 nm) |
| C2 | Silica film-coated aluminum pigment |
| | (Preparation Example 2, Particle diameter: 11 μm, |
| | Coated amount of the silica film: 3.5% by mass in terms of Si, |
| | Thickness of the silica film: 18 nm) |
| C3 | Silica film-coated aluminum pigment |
| | (Preparation Example 2, Particle diameter: 11 μm, |
| | Coated amount of the silica film: 7% by mass in terms of Si, |
| | Thickness of the silica film: 35 nm) |
| C4 | Silica film-coated aluminum pigment |
| | (Preparation Example 2, Particle diameter: 11 μm, |
| | Coated amount of the silica film: 10% by mass in terms of Si, |
| | Thickness of the silica film: 50 nm) |
| C5 | Silica film-coated aluminum pigment |
| | (Preparation Example 2, Particle diameter: 11 μm, |
| | Coated amount of the silica film: 20% by mass in terms of Si, |
| | Thickness of the silica film: 100 nm) |
| C6 | Acrylic resin film-coated aluminum pigment |
| | (Preparation Example 3, Particle diameter: 18 μm, |
| | Coated amount of the acrylic resin film: 12% by mass) |
| C7 | Molybdic acid film-coated aluminum pigment |
| | (Preparation Example 4, Particle diameter: 16 μm, |
| | Coated amount of the molybdic acid film: 2.5% by mass in |
| | terms of Mo) |
| C8 | Phosphoric acid film-coated aluminum pigment |
| | (Preparation Example 5, Particle diameter: 16 μm, |
| | Coated amount of the phosphoric acid film: 1.0% by mass in |
| | terms of P) |
| C9 | Phosphoric acid film and acrylic resin film-coated aluminum |
| | pigment (Preparation Example 6, Particle diameter: 11 μm, |
| | Coated amount of the phosphoric acid film: 1.0% by mass in |
| | terms of P, Coated amount of the acrylic resin film: 9% by |
| | mass) |
| C10 | Silica film-coated aluminum pigment |
| | (Preparation Example 7, Particle diameter: 6 μm, |
| | Coated amount of the silica film: 7% by mass in terms of Si, |
| | Thickness of the silica film: 35 nm) |
| C11 | Silica film-coated aluminum pigment |
| | (Preparation Example 8, Particle diameter: 9 μm, |
| | Coated amount of the silica film: 7% by mass in terms of Si, |
| | Thickness of the silica film: 35 nm) |
| C12 | Silica film-coated aluminum pigment |
| | (Preparation Example 9, Particle diameter: 16 μm, |
| | Coated amount of the silica film: 3.5% by mass in terms of Si, |
| | Thickness of the silica film: 18 nm) |
| C13 | Silica film-coated aluminum pigment |
| | (Preparation Example 10, Particle diameter: 20 μm, |
| | Coated amount of the silica film: 3.5% by mass in terms of Si, |
| | Thickness of the silica film: 18 nm) |
| C14 | Silica film-coated aluminum pigment |
| | (Preparation Example 11, Particle diameter: 25 μm, |
| | Coated amount of the silica film: 3.5% by mass in terms of Si, |
| | Thickness of the silica film: 18 nm) |
| C15 | Silica film-coated aluminum pigment |
| | (Preparation Example 12, Particle diameter: 30 μm, |
| | Coated amount of the silica film: 3.5% by mass in terms of Si, |
| | Thickness of the silica film: 18 nm) |
| C16 | Silica film-coated aluminum pigment |
| | (Preparation Example 13, Particle diameter: 36 μm, |
| | Coated amount of the silica film: 3.5% by mass in terms of Si, |
| | Thickness of the silica film: 18 nm) |
| C17 | Aluminum pigment (Showa Aluminum Powder K.K., Sap |
| | FM4010) |
| C18 | Aluminum pigment (Showa Aluminum Powder K.K., Sap |
| | 616FP) |
| C19 | Aluminum pigment (Showa Aluminum Powder K.K., Sap |
| | 561PS) |

TABLE 13

| No. | Silica particle (D) |
|---|---|
| D1 | Colloidal silica (Nissan Chemical Industries, Ltd., |
| | SNOWTEX ® NXS, Particle diameter: 5 nm) |
| D2 | Colloidal silica (Nissan Chemical Industries, Ltd., |
| | SNOWTEX ® N, Particle diameter: 15 nm) |
| D3 | Colloidal silica (Nissan Chemical Industries, Ltd., |
| | SNOWTEX ® XL, Particle diameter: 50 nm) |
| D4 | Colloidal silica (Nissan Chemical Industries, Ltd., |
| | SNOWTEX ® YL, Particle diameter: 65 nm) |
| D5 | Colloidal silica (Nissan Chemical Industries, Ltd., |
| | MP-1040, Particle diameter: 100 nm) |
| D6 | Colloidal silica (Nissan Chemical Industries, Ltd., |
| | MP-2040, Particle diameter: 200 nm) |

TABLE 14

| No. | Polyolefin resin particle (E) |
|---|---|
| E1 | Polyethylene (Mitsui Chemicals, Inc. |
| | CHEMIPEARL ® XWF3001, Particle diameter: 0.15 μm) |
| E2 | Polyethylene (Mitsui Chemicals, Inc. |
| | CHEMIPEARL ® W950, Particle diameter: 0.6 μm) |
| E3 | Polyethylene (Mitsui Chemicals, Inc. |
| | CHEMIPEARL ® WF640, Particle diameter: 1.0 μm) |
| E4 | Polyethylene (Mitsui Chemicals, Inc. |
| | CHEMIPEARL ® W500, Particle diameter: 2.5 μm) |
| E5 | Polyethylene (Mitsui Chemicals, Inc. |
| | CHEMIPEARL ® W400, Particle diameter: 4.0 μm) |
| E6 | Polypropylene (Mitsui Chemicals, Inc. |
| | CHEMIPEARL ® WP100, Particle diameter: 1.0 μm) |

### (4) Coated Metal Sheet

As explained in (3) above, the composition, thickness, and highest baking temperature of the coating film α of the coated metal sheet on which the coating film α was formed are shown in Table 15 below.

TABLE 15

| | | | Coating film (α) | | | | | | | | | | | | | |
|---|---|---|---|---|---|---|---|---|---|---|---|---|---|---|---|---|
| | | | | | | | | | | | Silica | | Polyolefin | | | |
| | | | | | | | Curing | | Aluminum | | particle | | resin | | | |
| | | Surface | Organic resin (A) | | | | agent(B) | | pigment (C) | | (D) | | particle (E) | | | |
| | | preparation | | *1 | | *1 | | *2 | | *3 | | *3 | | *3 | | Highest |
| | Metal | layer | | Amount | | Amount | | Amount | | Amount | | Amount | | Amount | Thickness | temp. |
| No. | sheet | (β) | Type | (%) | Type | (% ) | Type | (%) | Type | ( % ) | Type | (%) | Type | (%) | (μm) | (° C.) |
| Ex. 1 | M1 | β8 | A1 | 70 | A3 | 30 | | | C2 | 20 | | | | | 5 | 200 |
| Ex. 2 | M1 | β8 | A1 | 70 | A3 | 30 | B1 | 20 | C2 | 20 | | | | | 5 | 200 |
| Ex. 3 | M1 | β8 | A1 | 70 | A3 | 30 | | | C2 | 20 | D2 | 10 | | | 5 | 200 |
| Ex. 4 | M1 | β8 | A1 | 70 | A3 | 30 | | | C2 | 20 | | | E3 | 1 | 3 | 200 |
| Ex. 5 | M1 | β8 | A1 | 70 | A3 | 30 | B1 | 20 | C2 | 20 | D2 | 10 | | | 5 | 200 |
| Ex. 6 | M1 | β8 | A1 | 70 | A3 | 30 | B1 | 20 | C2 | 20 | | | E3 | 3 | 5 | 200 |
| Ex. 7 | M1 | β8 | A1 | 70 | A3 | 30 | | | C2 | 20 | D2 | 10 | E3 | 3 | 5 | 200 |
| Ex. 8 | M1 | β8 | A1 | 70 | A3 | 30 | B1 | 20 | C2 | 20 | D2 | 10 | E3 | 3 | 5 | 200 |
| Ex. 9 | M1 | β8 | A1 | 100 | | | B1 | 20 | C2 | 20 | D2 | 10 | E3 | 3 | 5 | 200 |
| Ex. 10 | M1 | β8 | A1 | 100 | | | | | C2 | 20 | D2 | 10 | E3 | 3 | 5 | 200 |
| Ex. 11 | M1 | β8 | A2 | 100 | | | B1 | 20 | C2 | 20 | D2 | 10 | E3 | 3 | 5 | 200 |
| Ex. 12 | M1 | β8 | A3 | 100 | | | B1 | 20 | C2 | 20 | D2 | 10 | E3 | 3 | 5 | 200 |
| Ex. 13 | M1 | β8 | A4 | 100 | | | B1 | 20 | C2 | 20 | D2 | 10 | E3 | 3 | 5 | 200 |
| Ex. 14 | M1 | β8 | A5 | 100 | | | B1 | 20 | C2 | 20 | D2 | 10 | E3 | 3 | 5 | 200 |
| Ex. 15 | M1 | β8 | A6 | 100 | | | B1 | 20 | C2 | 20 | D2 | 10 | E3 | 3 | 5 | 200 |
| Ex. 16 | M1 | β8 | A1 | 50 | A3 | 50 | B1 | 20 | C2 | 20 | D2 | 10 | E3 | 3 | 5 | 200 |
| Ex. 17 | M1 | β8 | A1 | 90 | A3 | 10 | B1 | 20 | C2 | 20 | D2 | 10 | E3 | 3 | 5 | 200 |
| Ex. 18 | M1 | β8 | A1 | 70 | A3 | 30 | B2 | 20 | C2 | 20 | D2 | 10 | E3 | 3 | 5 | 200 |
| Ex. 19 | M1 | β8 | A1 | 70 | A3 | 30 | B3 | 20 | C2 | 20 | D2 | 10 | E3 | 3 | 5 | 200 |
| Ex. 20 | M1 | β8 | A1 | 70 | A3 | 30 | B1 | 20 | C1 | 20 | D2 | 10 | E3 | 3 | 5 | 200 |
| Ex. 21 | M1 | β8 | A1 | 70 | A3 | 30 | B1 | 20 | C3 | 20 | D2 | 10 | E3 | 3 | 5 | 200 |
| Ex. 22 | M1 | β8 | A1 | 70 | A3 | 30 | B1 | 20 | C4 | 20 | D2 | 10 | E3 | 3 | 5 | 200 |
| Ex. 23 | M1 | β8 | A1 | 70 | A3 | 30 | B1 | 20 | C5 | 20 | D2 | 10 | E3 | 3 | 5 | 200 |
| Ex. 24 | M1 | β8 | A1 | 70 | A3 | 30 | B1 | 20 | C6 | 20 | D2 | 10 | E3 | 3 | 5 | 200 |
| Ex. 25 | M1 | β8 | A1 | 70 | A3 | 30 | B1 | 20 | C7 | 20 | D2 | 10 | E3 | 3 | 5 | 200 |
| Ex. 26 | M1 | β8 | A1 | 70 | A3 | 30 | B1 | 20 | C8 | 20 | D2 | 10 | E3 | 3 | 5 | 200 |
| Ex. 27 | M1 | β8 | A1 | 70 | A3 | 30 | B1 | 20 | C9 | 20 | D2 | 10 | E3 | 3 | 5 | 200 |
| Ex. 28 | M1 | β8 | A1 | 70 | A3 | 30 | B1 | 20 | C10 | 20 | D2 | 10 | E3 | 3 | 5 | 200 |
| Ex. 29 | M1 | β8 | A1 | 70 | A3 | 30 | B1 | 20 | C11 | 20 | D2 | 10 | E3 | 3 | 5 | 200 |
| Ex. 30 | M1 | β8 | A1 | 70 | A3 | 30 | B1 | 20 | C12 | 20 | D2 | 10 | E3 | 3 | 5 | 200 |
| Ex. 31 | M1 | β8 | A1 | 70 | A3 | 30 | B1 | 20 | C13 | 20 | D2 | 10 | E3 | 3 | 5 | 200 |
| Ex. 32 | M1 | β8 | A1 | 70 | A3 | 30 | B1 | 20 | C14 | 20 | D2 | 10 | E3 | 3 | 5 | 200 |
| Ex. 33 | M1 | β8 | A1 | 70 | A3 | 30 | B1 | 20 | C15 | 20 | D2 | 10 | E3 | 3 | 5 | 200 |
| Ex. 34 | M1 | β8 | A1 | 70 | A3 | 30 | B1 | 20 | C16 | 20 | D2 | 10 | E3 | 3 | 5 | 200 |
| Ex. 35 | M1 | β8 | A1 | 70 | A3 | 30 | B1 | 20 | C2 | 7 | D2 | 10 | E3 | 3 | 5 | 200 |
| Ex. 36 | M1 | β8 | A1 | 70 | A3 | 30 | B1 | 20 | C2 | 10 | D2 | 10 | E3 | 3 | 5 | 200 |
| Ex. 37 | M1 | β8 | A1 | 70 | A3 | 30 | B1 | 20 | C2 | 15 | D2 | 10 | E3 | 3 | 5 | 200 |
| Ex. 38 | M1 | β8 | A1 | 70 | A3 | 30 | B1 | 20 | C2 | 25 | D2 | 10 | E3 | 3 | 5 | 200 |
| Ex. 39 | M1 | β8 | A1 | 70 | A3 | 30 | B1 | 20 | C2 | 30 | D2 | 10 | E3 | 3 | 5 | 200 |
| Ex. 40 | M1 | β8 | A1 | 70 | A3 | 30 | B1 | 20 | C2 | 35 | D2 | 10 | E3 | 3 | 5 | 200 |
| Ex. 41 | M1 | β8 | A1 | 70 | A3 | 30 | B1 | 20 | C2 | 40 | D2 | 10 | E3 | 3 | 5 | 200 |
| Ex. 42 | M1 | β8 | A1 | 70 | A3 | 30 | B1 | 20 | C9 | 7 | D2 | 10 | E3 | 3 | 5 | 200 |
| Ex. 43 | M1 | β8 | A1 | 70 | A3 | 30 | B1 | 20 | C9 | 10 | D2 | 10 | E3 | 3 | 5 | 200 |
| Ex. 44 | M1 | β8 | A1 | 70 | A3 | 30 | B1 | 20 | C9 | 15 | D2 | 10 | E3 | 3 | 5 | 200 |
| Ex. 45 | M1 | β8 | A1 | 70 | A3 | 30 | B1 | 20 | C9 | 25 | D2 | 10 | E3 | 3 | 5 | 200 |
| Ex. 46 | M1 | β8 | A1 | 70 | A3 | 30 | B1 | 20 | C9 | 30 | D2 | 10 | E3 | 3 | 5 | 200 |
| Ex. 47 | M1 | β8 | A1 | 70 | A3 | 30 | B1 | 20 | C9 | 35 | D2 | 10 | E3 | 3 | 5 | 200 |
| Ex. 48 | M1 | β8 | A1 | 70 | A3 | 30 | B1 | 20 | C9 | 40 | D2 | 10 | E3 | 3 | 5 | 200 |
| Ex. 49 | M1 | β8 | A1 | 70 | A3 | 30 | B1 | 20 | C2 | 20 | D1 | 10 | E3 | 3 | 5 | 200 |
| Ex. 50 | M1 | β8 | A1 | 70 | A3 | 30 | B1 | 20 | C2 | 20 | D3 | 10 | E3 | 3 | 5 | 200 |
| Ex. 51 | M1 | β8 | A1 | 70 | A3 | 30 | B1 | 20 | C2 | 20 | D4 | 10 | E3 | 3 | 5 | 200 |
| Ex. 52 | M1 | β8 | A1 | 70 | A3 | 30 | B1 | 20 | C2 | 20 | D5 | 10 | E3 | 3 | 5 | 200 |
| Ex. 53 | M1 | β8 | A1 | 70 | A3 | 30 | B1 | 20 | C2 | 20 | D6 | 10 | E3 | 3 | 5 | 200 |
| Ex. 54 | M1 | β8 | A1 | 70 | A3 | 30 | B1 | 20 | C2 | 20 | D2 | 3 | E3 | 3 | 5 | 200 |
| Ex. 55 | M1 | β8 | A1 | 70 | A3 | 30 | B1 | 20 | C2 | 20 | D2 | 5 | E3 | 3 | 5 | 200 |
| Ex. 56 | M1 | β8 | A1 | 70 | A3 | 30 | B1 | 20 | C2 | 20 | D2 | 20 | E3 | 3 | 5 | 200 |
| Ex. 57 | M1 | β8 | A1 | 70 | A3 | 30 | B1 | 20 | C2 | 20 | D2 | 25 | E3 | 3 | 5 | 200 |
| Ex. 58 | M1 | β8 | A1 | 70 | A3 | 30 | B1 | 20 | C2 | 20 | D2 | 10 | E1 | 3 | 5 | 200 |
| Ex. 59 | M1 | β8 | A1 | 70 | A3 | 30 | B1 | 20 | C2 | 20 | D2 | 10 | E2 | 3 | 5 | 200 |
| Ex. 60 | M1 | β8 | A1 | 70 | A3 | 30 | B1 | 20 | C2 | 20 | D2 | 10 | E4 | 3 | 5 | 200 |
| Ex. 61 | M1 | β8 | A1 | 70 | A3 | 30 | B1 | 20 | C2 | 20 | D2 | 10 | E5 | 3 | 5 | 200 |
| Ex. 62 | M1 | β8 | A1 | 70 | A3 | 30 | B1 | 20 | C2 | 20 | D2 | 10 | E6 | 3 | 5 | 200 |
| Ex. 63 | M1 | β8 | A1 | 70 | A3 | 30 | B1 | 20 | C2 | 20 | D2 | 10 | E3 | 0.3 | 5 | 200 |
| Ex. 64 | M1 | β8 | A1 | 70 | A3 | 30 | B1 | 20 | C2 | 20 | D2 | 10 | E3 | 0.5 | 5 | 200 |
| Ex. 65 | M1 | β8 | A1 | 70 | A3 | 30 | B1 | 20 | C2 | 20 | D2 | 10 | E3 | 1.5 | 5 | 200 |
| Ex. 66 | M1 | β8 | A1 | 70 | A3 | 30 | B1 | 20 | C2 | 20 | D2 | 10 | E3 | 5 | 5 | 200 |
| Ex. 67 | M1 | β8 | A1 | 70 | A3 | 30 | B1 | 20 | C2 | 20 | D2 | 10 | E3 | 7 | 5 | 200 |
| Ex. 68 | M1 | β8 | A1 | 70 | A3 | 30 | B1 | 20 | C2 | 20 | D2 | 10 | E3 | 3 | 2 | 200 |
| Ex. 69 | M1 | β8 | A1 | 70 | A3 | 30 | B1 | 20 | C2 | 20 | D2 | 10 | E3 | 3 | 3 | 200 |
| Ex. 70 | M1 | β8 | A1 | 70 | A3 | 30 | B1 | 20 | C2 | 20 | D2 | 10 | E3 | 3 | 7 | 200 |
| Ex. 71 | M1 | β8 | A1 | 70 | A3 | 30 | B1 | 20 | C2 | 20 | D2 | 10 | E3 | 3 | 10 | 200 |
| Ex. 72 | M1 | | A1 | 70 | A3 | 30 | B1 | 20 | C2 | 20 | D2 | 10 | | | 5 | 200 |
| Ex. 73 | M1 | | A1 | 70 | A3 | 30 | B1 | 20 | C2 | 20 | | | E3 | 3 | 5 | 200 |
| Ex. 74 | M1 | | A1 | 70 | A3 | 30 | | | C2 | 20 | D2 | 10 | E3 | 3 | 5 | 200 |
| Ex. 75 | M1 | | A1 | 70 | A3 | 30 | B1 | 20 | C2 | 20 | D2 | 10 | E3 | 3 | 5 | 200 |
| Ex. 76 | M1 | β1 | A1 | 70 | A3 | 30 | B1 | 20 | C2 | 20 | D2 | 10 | E3 | 3 | 5 | 200 |
| Ex. 77 | M1 | β2 | A1 | 70 | A3 | 30 | B1 | 20 | C2 | 20 | D2 | 10 | E3 | 3 | 5 | 200 |
| Ex. 78 | M1 | β3 | A1 | 70 | A3 | 30 | B1 | 20 | C2 | 20 | D2 | 10 | E3 | 3 | 5 | 200 |
| Ex. 79 | M1 | β4 | A1 | 70 | A3 | 30 | B1 | 20 | C2 | 20 | D2 | 10 | E3 | 3 | 5 | 200 |
| Ex. 80 | M1 | β5 | A1 | 70 | A3 | 30 | B1 | 20 | C2 | 20 | D2 | 10 | E3 | 3 | 5 | 200 |
| Ex. 81 | M1 | β6 | A1 | 70 | A3 | 30 | B1 | 20 | C2 | 20 | D2 | 10 | E3 | 3 | 5 | 200 |
| Ex. 82 | M1 | β7 | A1 | 70 | A3 | 30 | B1 | 20 | C2 | 20 | D2 | 10 | E3 | 3 | 5 | 200 |
| Ex. 83 | M1 | β9 | A1 | 70 | A3 | 30 | B1 | 20 | C2 | 20 | D2 | 10 | E3 | 3 | 5 | 200 |
| Ex. 84 | M1 | β10 | A1 | 70 | A3 | 30 | B1 | 70 | C2 | 20 | D2 | 10 | E3 | 3 | 5 | 200 |
| Ex. 85 | M1 | β11 | A1 | 70 | A3 | 30 | B1 | 20 | C2 | 20 | D2 | 10 | E3 | 3 | 5 | 200 |
| Ex. 86 | M1 | β12 | A1 | 70 | A3 | 30 | B1 | 20 | C2 | 20 | D2 | 10 | E3 | 3 | 5 | 200 |
| Ex. 87 | M1 | β13 | A1 | 70 | A3 | 30 | B1 | 20 | C2 | 20 | D2 | 10 | E3 | 3 | 5 | 200 |
| Ex. 88 | M1 | β14 | A1 | 70 | A3 | 30 | B1 | 20 | C2 | 20 | D2 | 10 | E3 | 3 | 5 | 200 |
| Ex. 89 | M1 | β15 | A1 | 70 | A3 | 30 | B1 | 20 | C2 | 20 | D2 | 10 | E3 | 3 | 5 | 200 |
| Ex. 90 | M1 | β16 | A1 | 70 | A3 | 30 | B1 | 20 | C2 | 20 | D2 | 10 | E3 | 3 | 5 | 200 |
| Ex. 91 | M1 | β17 | A1 | 70 | A3 | 30 | B1 | 20 | C2 | 20 | D2 | 10 | E3 | 3 | 5 | 200 |
| Ex. 92 | M2 | β8 | A1 | 70 | A3 | 30 | B1 | 20 | C2 | 20 | D2 | 10 | E3 | 3 | 5 | 200 |
| Ex. 93 | M2 | β8 | A1 | 100 | | | B1 | 20 | C2 | 20 | D2 | 10 | E3 | 3 | 5 | 200 |
| Ex. 94 | M2 | β8 | A1 | 70 | A3 | 30 | B1 | 20 | C9 | 20 | D2 | 10 | E3 | 3 | 5 | 200 |
| Ex. 95 | M2 | | A1 | 70 | A3 | 30 | B1 | 20 | C2 | 20 | D2 | 10 | E3 | 3 | 5 | 200 |
| Ex. 96 | M3 | β8 | A1 | 70 | A3 | 30 | B1 | 20 | C2 | 20 | D2 | 10 | E3 | 3 | 5 | 200 |
| Ex. 97 | M3 | β8 | A1 | 100 | | | B1 | 20 | C2 | 20 | D2 | 10 | E3 | 3 | 5 | 200 |
| Ex. 98 | M3 | β8 | A1 | 70 | A3 | 30 | B1 | 70 | C9 | 20 | D2 | 10 | E3 | 3 | 5 | 200 |
| Ex. 99 | M3 | | A1 | 70 | A3 | 30 | B1 | 20 | C2 | 20 | D2 | 10 | E3 | 3 | 5 | 200 |
| Ex. 100 | M4 | β8 | A1 | 70 | A3 | 30 | B1 | 20 | C2 | 20 | D2 | 10 | E3 | 3 | 5 | 200 |
| Ex. 101 | M4 | β8 | A1 | 100 | | | B1 | 20 | C2 | 20 | D2 | 10 | E3 | 3 | 5 | 200 |
| Ex. 102 | M4 | β8 | A1 | 70 | A3 | 30 | B1 | 20 | C9 | 20 | D2 | 10 | E3 | 3 | 5 | 200 |
| Ex. 103 | M4 | | A1 | 70 | A3 | 30 | B1 | 20 | C2 | 20 | D2 | 10 | E3 | 3 | 5 | 200 |
| Ex. 104 | M5 | β8 | A1 | 70 | A3 | 30 | Bl | 20 | C2 | 20 | D2 | 10 | E3 | 3 | 5 | 200 |
| Ex. 105 | M5 | β8 | A1 | 100 | | | B1 | 20 | C2 | 20 | D2 | 10 | E3 | 3 | 5 | 200 |
| Ex. 106 | M5 | β8 | A1 | 70 | A3 | 30 | B1 | 20 | C9 | 20 | D2 | 10 | E3 | 3 | 5 | 200 |
| Ex. 107 | M5 | | A1 | 70 | A3 | 30 | B1 | 20 | C2 | 20 | D2 | 10 | E3 | 3 | 5 | 200 |
| Ex. 108 | M6 | β8 | A1 | 70 | A3 | 30 | B1 | 20 | C2 | 20 | D2 | 10 | E3 | 3 | 5 | 200 |
| Ex. 109 | M6 | β8 | A1 | 100 | | | B1 | 20 | C2 | 20 | D2 | 10 | E3 | 3 | 5 | 200 |
| Ex. 110 | M6 | β8 | A1 | 70 | A3 | 30 | B1 | 20 | C9 | 20 | D2 | 10 | E3 | 3 | 5 | 200 |
| Ex. 111 | M6 | | A1 | 70 | A3 | 30 | B1 | 20 | C2 | 20 | D2 | 10 | E3 | 3 | 5 | 200 |
| Ex. 112 | M7 | β8 | A1 | 70 | A3 | 30 | B1 | 20 | C2 | 20 | D2 | 10 | E3 | 3 | 5 | 200 |
| Ex. 113 | M7 | β8 | A1 | 100 | | | B1 | 20 | C2 | 20 | D2 | 10 | E3 | 3 | 5 | 200 |
| Ex. 114 | M7 | β8 | A1 | 70 | A3 | 30 | B1 | 20 | C9 | 20 | D2 | 10 | E3 | 3 | 5 | 200 |
| Ex. 115 | M7 | | A1 | 70 | A3 | 30 | B1 | 20 | C2 | 20 | D2 | 10 | E3 | 3 | 5 | 200 |
| Ex. 116 | M8 | β8 | A1 | 70 | A3 | 30 | B1 | 20 | C2 | 20 | D2 | 10 | E3 | 3 | 5 | 200 |
| Ex. 117 | M8 | β8 | A1 | 100 | | | B1 | 20 | C2 | 20 | D2 | 10 | E3 | 3 | 5 | 200 |
| Ex. 118 | M8 | β8 | A1 | 70 | A3 | 30 | B1 | 20 | C9 | 20 | D2 | 10 | E3 | 3 | 5 | 200 |
| Ex. 119 | M8 | | A1 | 70 | A3 | 30 | B1 | 20 | C2 | 20 | D2 | 10 | E3 | 3 | 5 | 200 |
| Ex. 120 | M1 | β8 | A1 | 70 | A3 | 30 | B1 | 20 | C2 | 20 | D2 | 10 | E3 | 3 | 1.5 | 200 |
| Comp. | M1 | β8 | A1 | 70 | A3 | 30 | B1 | 20 | C17 | 20 | D2 | 10 | E3 | 3 | 5 | 200 |
| Ex. 1 | | | | | | | | | | | | | | | | |
| Comp. | M1 | β8 | A1 | 70 | A3 | 30 | B1 | 20 | C18 | 20 | D2 | 10 | E3 | 3 | 5 | 200 |
| Ex. 2 | | | | | | | | | | | | | | | | |
| Comp. | M1 | β8 | A1 | 70 | A3 | 30 | B1 | 20 | C19 | 20 | D2 | 10 | E3 | 3 | 5 | 200 |
| Ex. 3 | | | | | | | | | | | | | | | | |
| Comp. | M1 | β8 | A1 | 70 | A3 | 30 | B1 | 20 | C2 | 20 | D2 | 10 | E3 | 3 | 1 | 200 |
| Ex. 4 | | | | | | | | | | | | | | | | |
| Comp. | M1 | β8 | A1 | 70 | A3 | 30 | B1 | 20 | C2 | 20 | D2 | 10 | E3 | 3 | 12 | 200 |
| Ex. 5 | | | | | | | | | | | | | | | | |
| Comp. | M1 | β8 | A1 | 70 | A3 | 30 | B1 | 20 | | | D2 | 10 | E3 | 3 | 5 | 200 |
| Ex. 6 | | | | | | | | | | | | | | | | |

*1: Percentage in the organic resin (% by mass of solid content)
*2: Percentage relative to 100% by mass of organic resin solid content (% by mass of solid content)
*3: Percentage in the coating film (α) (% by mass of solid content)

### (5) Evaluation Test

The design characteristics, corrosion resistance, coating film adhesion (processing adhesion and water resisting adhesion), chemical resistance, and scratch resistance of the coated metal sheet (test sheet), which was prepared as explained in (3) above, were evaluated in accordance with the evaluation method and evaluation standards below. The results are shown in Table 16.

### (Design Characteristics)

The design characteristics of the test sheet was visually observed and evaluated in accordance with the following evaluation standards. Moreover, G value (Glossiness) was evaluated using a 60°/60° gloss meter in accordance with JIS Z 8741.

5: Both of metallic color and surface burnish are uniform, the substrate is not completely seen through, and the G value is 25 or more
4: Both of metallic color and surface burnish are uniform, the substrate is not completely seen through, and the G value is 20 or more and less than 25
3: Both of metallic color and surface burnish are uniform, the substrate is not completely seen through, and the G value is less than 20
2: The substrate is slightly seen through (the substrate could be confirmed by staring) or fine cracking is generated in the coating film (the cracking could be confirmed by staring)
1: The substrate is seen through (the substrate could be easily observed), or cracking is generated in the coating film (the cracking could be easily observed)

### (Corrosion Resistance)

After sealing a tape on the end surface of the test sheet, salt spray test (SST) was carried out for 120 hours in accordance with JIS Z 2371. The rust generation conditions were observed, and evaluated along the following evaluation standards.

5: White rust and blackening are not generated
4: A ratio of an area at which white rust and blackening were generated is less than 1%
3: A ratio of an area at which white rust and blackening were generated is 1% or more and less than 2.5%
2: A ratio of an area at which white rust and blackening were generated is 2.5% or more and less than 5%
1: A ratio of an area at which white rust and blackening were generated is 5% or more

### (Coating Film Adhesion (Processing Adhesion))

After bending the test sheet at 180°, tape peeling test (in accordance with JIS K 5600-5-6) was carried out at the outside of the bent pan of the test sheet. Then, the appearance of the area from which the tape was peeled was evaluated in accordance with the following standards. Moreover, the bending was carried out by inserting a space of 0.5 mm in thickness at 20° C. (in general, it is called “1T bending”)

5: Peeling is not observed in the coating film
4: Peeling is observed only at a small part of the coating film (peeling is barely observed using a loupe)
3: Peeling is observed at a part of the coating film (peeling is observed using a loupe)
2: Partial peeling is observed in the coating film (peeling is observed with eyes)
1: Peeling is observed in almost all of the coating film (peeling is easily observed with eyes)

### (Coating Film Adhesion (Water Resisting Adhesion))

The test sheet was immersed in boiling water for 30 minutes, and removed. After leaving it at room temperature for 24 hours, 100 cut flaws were made in the test sheet at intervals of 1 mm in a checkerboard pattern. Then tape peeling test was carried out using the test sheet. Making cut flaws in a checkerboard pattern, and peeling the tape were carried out in accordance with JIS-K 5400. 8. 2 and JIS-K 5400. 8. 5. The results were evaluated using the following standards.

5: A number of peeled square is 0
4: A number of peeled square is 1 or 2
3: A number of peeled square is in a range of 3 to 5
2: A number of peeled square is in a range of 6 to 10
1: A number of peeled square is II or more

### (Chemical Resistance)

After setting the test sheet in a rubbing tester, the surface of the test sheet was rubbed using a cotton impregnated with ethanol back and forth 10 times with a load of 49.03 kPa (0.5 kgf/cm²). Then the conditions of the coating film of the test sheet were evaluated using the following standards.

5: Rubbed surface has not tracks at all
4: Rubbed surface has very slight tracks (rubbed tracks can be barely observed by staring)
3: Rubbed surface has light tracks (rubbed tracks can be easily observed by staring)
2: Rubbed surface has clear tracks (rubbed tracks can be easily observed in a moment)
1: Coating film is dissolved in the rubbed surface, and the substrate was exposed

### (Scratch Resistance)

The test sheet was scratched by 5 lines by a lead pencil at an angle of 45° and the scratch resistance was evaluated by the pencil hardness by which no scratches were formed at 2 lines or more. As the lead pencil. Uni pencil marketed by Mitsubishi Pencil Co., Ltd. was used. The test was carried out in accordance with JIS K 5600-5-4 at 20° C. with a load of 4.903 N (500 gf). The results were evaluated using the following standards.

5: Pencil hardness of 3H or more
4: Pencil hardness of 2H
3: Pencil hardness of H
2 Pencil hardness of F
1: Pencil hardness of HB or less

TABLE 16

| | | | Coating film adhesion | | | |
|---|---|---|---|---|---|---|
| | | | | Water- | | |
| | Design | Corrosion | Processing | resisting | Chemical | Scratch |
| No. | characteristics | resistance | adhesion | adhesion | resistance | resistance |
| Example 1 | 5 | 3 | 5 | 4 | 3 | 3 |
| Example 2 | 5 | 3 | 5 | 5 | 5 | 3 |
| Example 3 | 5 | 4 | 5 | 4 | 3 | 3 |
| Example 4 | 5 | 3 | 5 | 4 | 3 | 3 |
| Example 5 | 5 | 5 | 5 | 5 | 5 | 4 |
| Example 6 | 5 | 3 | 5 | 5 | 5 | 4 |
| Example 7 | 5 | 4 | 5 | 4 | 3 | 4 |
| Example 8 | 5 | 5 | 5 | 5 | 5 | 5 |
| Example 9 | 5 | 4 | 5 | 4 | 5 | 5 |
| Example 10 | 5 | 3 | 5 | 3 | 3 | 4 |
| Example 11 | 5 | 4 | 5 | 4 | 4 | 5 |
| Example 12 | 5 | 5 | 4 | 5 | 3 | 5 |
| Example 13 | 4 | 3 | 4 | 4 | 3 | 4 |
| Example 14 | 5 | 3 | 3 | 4 | 3 | 5 |
| Example 15 | 5 | 4 | 3 | 3 | 5 | 4 |
| Example 16 | 5 | 5 | 5 | 5 | 4 | 5 |
| Example 17 | 5 | 4 | 5 | 5 | 5 | 5 |
| Example 18 | 5 | 5 | 5 | 5 | 5 | 5 |
| Example 19 | 5 | 4 | 5 | 5 | 4 | 4 |
| Example 20 | 5 | 3 | 5 | 5 | 5 | 5 |
| Example 21 | 5 | 5 | 5 | 5 | 5 | 5 |
| Example 22 | 5 | 5 | 5 | 5 | 5 | 5 |
| Example 23 | 3 | 5 | 5 | 5 | 5 | 5 |
| Example 24 | 4 | 4 | 5 | 5 | 5 | 5 |
| Example 25 | 5 | 3 | 5 | 5 | 5 | 5 |
| Example 26 | 5 | 3 | 5 | 5 | 5 | 5 |
| Example 27 | 5 | 5 | 5 | 5 | 5 | 5 |
| Example 28 | 4 | 5 | 5 | 5 | 5 | 5 |
| Example 29 | 5 | 5 | 5 | 5 | 5 | 5 |
| Example 30 | 5 | 5 | 5 | 5 | 5 | 5 |
| Example 31 | 5 | 5 | 5 | 5 | 5 | 5 |
| Example 32 | 5 | 5 | 5 | 5 | 5 | 5 |
| Example 33 | 4 | 5 | 5 | 5 | 5 | 5 |
| Example 34 | 4 | 4 | 5 | 5 | 5 | 5 |
| Example 35 | 3 | 5 | 5 | 5 | 5 | 5 |
| Example 36 | 4 | 5 | 5 | 5 | 5 | 5 |
| Example 37 | 5 | 5 | 5 | 5 | 5 | 5 |
| Example 38 | 5 | 5 | 5 | 5 | 5 | 5 |
| Example 39 | 5 | 5 | 5 | 5 | 5 | 5 |
| Example 40 | 5 | 4 | 5 | 4 | 5 | 5 |
| Example 41 | 5 | 3 | 4 | 3 | 5 | 5 |
| Example 42 | 3 | 5 | 5 | 5 | 5 | 5 |
| Example 43 | 4 | 5 | 5 | 5 | 5 | 5 |
| Example 44 | 4 | 5 | 5 | 5 | 5 | 5 |
| Example 45 | 4 | 5 | 5 | 5 | 5 | 5 |
| Example 46 | 4 | 5 | 5 | 5 | 5 | 5 |
| Example 47 | 4 | 4 | 5 | 4 | 5 | 5 |
| Example 48 | 4 | 3 | 4 | 3 | 5 | 5 |
| Example 49 | 5 | 5 | 5 | 5 | 5 | 5 |
| Example 50 | 5 | 5 | 5 | 5 | 5 | 5 |
| Example 51 | 5 | 4 | 5 | 5 | 5 | 5 |
| Example 52 | 5 | 4 | 5 | 5 | 5 | 5 |
| Example 53 | 4 | 3 | 5 | 5 | 5 | 5 |
| Example 54 | 5 | 4 | 5 | 5 | 5 | 5 |
| Example 55 | 5 | 5 | 5 | 5 | 5 | 5 |
| Example 56 | 5 | 5 | 5 | 5 | 5 | 5 |
| Example 57 | 5 | 5 | 4 | 4 | 5 | 5 |
| Example 58 | 5 | 5 | 5 | 5 | 5 | 4 |
| Example 59 | 5 | 5 | 5 | 5 | 5 | 5 |
| Example 60 | 5 | 5 | 5 | 5 | 5 | 5 |
| Example 61 | 4 | 4 | 5 | 5 | 5 | 5 |
| Example 62 | 5 | 5 | 5 | 5 | 5 | 5 |
| Example 63 | 5 | 5 | 5 | 5 | 5 | 4 |
| Example 64 | 5 | 5 | 5 | 5 | 5 | 5 |
| Example 65 | 5 | 5 | 5 | 5 | 5 | 5 |
| Example 66 | 5 | 5 | 5 | 5 | 5 | 5 |
| Example 67 | 4 | 4 | 5 | 5 | 5 | 5 |
| Example 68 | 3 | 3 | 5 | 5 | 5 | 4 |
| Example 69 | 4 | 4 | 5 | 5 | 5 | 5 |
| Example 70 | 5 | 5 | 5 | 5 | 5 | 5 |
| Example 71 | 4 | 4 | 4 | 5 | 5 | 5 |
| Example 72 | 5 | 3 | 3 | 4 | 5 | 4 |
| Example 73 | 5 | 3 | 3 | 4 | 5 | 4 |
| Example 74 | 5 | 3 | 3 | 3 | 3 | 4 |
| Example 75 | 5 | 3 | 3 | 4 | 5 | 5 |
| Example 76 | 5 | 3 | 4 | 4 | 5 | 5 |
| Example 77 | 5 | 3 | 4 | 4 | 5 | 5 |
| Example 78 | 5 | 3 | 4 | 4 | 5 | 5 |
| Example 79 | 5 | 3 | 4 | 4 | 5 | 5 |
| Example 80 | 5 | 4 | 5 | 4 | 5 | 5 |
| Example 81 | 5 | 4 | 5 | 5 | 5 | 5 |
| Example 82 | 5 | 4 | 5 | 5 | 5 | 5 |
| Example 83 | 5 | 3 | 4 | 4 | 5 | 5 |
| Example 84 | 5 | 4 | 4 | 4 | 5 | 5 |
| Example 85 | 5 | 4 | 4 | 4 | 5 | 5 |
| Example 86 | 5 | 5 | 4 | 5 | 5 | 5 |
| Example 87 | 5 | 5 | 4 | 5 | 5 | 5 |
| Example 88 | 5 | 5 | 4 | 5 | 5 | 5 |
| Example 89 | 5 | 5 | 4 | 5 | 5 | 5 |
| Example 90 | 5 | 5 | 5 | 5 | 5 | 5 |
| Example 91 | 5 | 5 | 5 | 5 | 5 | 5 |
| Example 92 | 5 | 5 | 5 | 5 | 5 | 5 |
| Example 93 | 5 | 4 | 5 | 4 | 5 | 5 |
| Example 94 | 4 | 5 | 5 | 5 | 5 | 5 |
| Example 95 | 5 | 3 | 3 | 4 | 5 | 5 |
| Example 96 | 5 | 5 | 5 | 5 | 5 | 5 |
| Example 97 | 5 | 4 | 5 | 4 | 5 | 5 |
| Example 98 | 4 | 5 | 5 | 5 | 5 | 5 |
| Example 99 | 5 | 3 | 3 | 4 | 5 | 5 |
| Example 100 | 5 | 5 | 5 | 5 | 5 | 5 |
| Example 101 | 5 | 5 | 5 | 4 | 5 | 5 |
| Example 102 | 4 | 5 | 5 | 5 | 5 | 5 |
| Example 103 | 5 | 4 | 3 | 4 | 5 | 5 |
| Example 104 | 5 | 5 | 5 | 5 | 5 | 5 |
| Example 105 | 5 | 5 | 5 | 4 | 5 | 5 |
| Example 106 | 4 | 5 | 5 | 5 | 5 | 5 |
| Example 107 | 5 | 4 | 3 | 4 | 5 | 5 |
| Example 108 | 5 | 5 | 5 | 5 | 5 | 5 |
| Example 109 | 5 | 5 | 5 | 4 | 5 | 5 |
| Example 110 | 4 | 5 | 5 | 5 | 5 | 5 |
| Example 111 | 5 | 5 | 3 | 4 | 5 | 5 |
| Example 112 | 5 | 5 | 5 | 5 | 5 | 5 |
| Example 113 | 5 | 5 | 5 | 4 | 5 | 5 |
| Example 114 | 4 | 5 | 5 | 5 | 5 | 5 |
| Example 115 | 5 | 5 | 3 | 4 | 5 | 5 |
| Example 116 | 5 | 5 | 5 | 5 | 5 | 5 |
| Example 117 | 5 | 5 | 5 | 4 | 5 | 5 |
| Example 118 | 4 | 5 | 5 | 5 | 5 | 5 |
| Example 119 | 5 | 5 | 3 | 4 | 5 | 5 |
| Example 120 | 3 | 3 | 5 | 5 | 5 | 3 |
| Comparative | 5 | 1 | 5 | 5 | 5 | 5 |
| Example 1 | | | | | | |
| Comparative | 5 | 1 | 5 | 5 | 5 | 5 |
| Example 2 | | | | | | |
| Comparative | 5 | 1 | 5 | 5 | 5 | 5 |
| Example 3 | | | | | | |
| Comparative | 1 | 2 | 5 | 5 | 5 | 2 |
| Example 4 | | | | | | |
| Comparative | 2 | 3 | 2 | 4 | 5 | 5 |
| Example 5 | | | | | | |
| Comparative | 1 | 5 | 5 | 5 | 5 | 4 |
| Example 6 | | | | | | |

Examples of the present invention had excellent design characteristics, corrosion resistance, coating film adhesion (processing adhesion and water resisting adhesion), chemical resistance, and scratch resistance in which the evaluation standard was 3 or more in all of the evaluation tests. Moreover, when the coating composition having a solid content of 30% among all coating compositions used in Examples was left at rest at 40° C., and thereby the storage stability was examined, the coating composition in Example 11 gelated after 2 weeks, and the coating composition in Example 13 gelated after 3 days. In other words, the coating composition containing the polyester resin A2 having a carboxyl group and no sulfonic acid group, and the coating composition containing the polyurethane resin A4 having a cationic functional group had inferior storage stability to that of other coating compositions.

On the other hand, Comparative Examples 1 to 3, which were out of the scope of the present invention, and used the aluminum pigment, the surface of which was not subjected to the deactivation treatment, had inferior corrosion resistance. Comparative Example 4 of which the thickness of the coating film α was 1 μm, which was out of the scope of the present invention, had inferior design characteristics and corrosion resistance. Comparative Example 5 of which the thickness of the coating film α was 12 μm, which was out of the scope of the present invention, had inferior design characteristics and processing adhesion. Comparative Example 6, which did not contain the aluminum pigment, had an inferior design characteristics.

The preferable embodiments of the present invention were explained above. However, the present invention is not limited to these embodiments. It is clear that a person skilled in the art can make various changes or modifications to the embodiments and still be within the scope of the claims, and that such changes or modifications are deservingly included in the technical scope of the present invention.

### INDUSTRIAL APPLICABILITY

The chromate-free coated metal sheet having metallic appearance according to the present invention does not contain hexavalent chromium having a high environmental load, is cheap, and extremely excellent in design characteristics (luster and concealing properties), corrosion resistance, coating film adhesion (processing adhesion, water resisting adhesion), scratch resistance, chemical resistance and the like. Therefore, the chromate-free coated metal sheet according to the present invention is promising as a metallic tone raw material which is cheap, is highly designable, adds a high amount of value, is compatible with the environment, and significantly contributes to various industries.

What is claimed is:

1. A chromate-free coated metal sheet including:
a metal sheet; and
a coating film α which contains an organic resin A as a film formation component and 7 to 40% by mass of a flaky aluminum pigment C having a deactivation-treated surface on at least one surface of the metal sheet,
wherein a surface of the aluminum pigment C is coated with a film containing at least one selected from the group consisting of a phosphoric acid compound, a molybdic acid compound, and silica, or a two-layer film including a film containing an acrylic resin and a film containing a phosphoric acid compound;
a thickness of the coating film α is in a range of 1.5 to 10 μm;
a surface of the metal sheet is coated with the single coating film α; and
the amount of the aluminum pigment C in the coating film α is in a range of 10 to 20% by mass.

2. The chromate-free coated metal sheet according to claim 1, wherein the coating film α further contains silica particles D having an average particle diameter of 5 to 100 nm.

3. The chromate-free coated metal sheet according to claim 1, wherein an average particle diameter of the aluminum pigment C is in a range of 5 to 30 μm.

4. The chromate-free coated metal sheet according to claim 1, wherein the surface of the aluminum pigment C is coated with the film containing silica.

5. The chromate-free coated metal sheet according to claim 4, wherein an amount of the film containing silica film in the silica film-coated aluminum pigment C_{Si} relative to 100% by mass of aluminum is in a range of 10 to 20% by mass in terms of Si.

6. The chromate-free coated metal sheet according to claim 4, wherein a thickness of the film containing silica is in a range of 5 to 100 nm.

7. The chromate-free coated metal sheet according to claim 1, wherein the coating film α further contains polyolefin resin particles E having an average particle diameter of 0.5 to 3 μm.

8. The chromate-free coated metal sheet according to claim 7, wherein an amount of the polyolefin resin particles E in the coating film α is in a range of 0.5 to 5% by mass.

9. The chromate-free coated metal sheet according to claim 1, wherein the organic resin A is a resin cured by a curing agent B.

10. The chromate-free coated metal sheet according to claim 1, wherein the organic resin A contains a polyester resin Ae having a sulfonic acid group in its structure.

11. The chromate-free coated metal sheet according to claim 10, wherein the organic resin A further contains a polyurethane resin having a carboxyl group and an urea group in its structure.

12. The chromate-free coated metal sheet according to claim 1, wherein a surface preparation layer β is included between the metal sheet and the coating film α.

13. The chromate-free coated metal sheet according to claim 1, wherein the metal sheet is a zinc-base plated steel sheet.

14. The chromate-free coated metal sheet, wherein the coating film α in claim 1 is formed by coating and drying by heat a water-based coating composition X containing constituent components of the coating film α on at least one surface of the metal sheet.

15. The chromate-free coated metal sheet according to claim 1, wherein the surface of the aluminum pigment C is coated with the film containing the phosphoric acid compound.

16. The chromate-free coated metal sheet according to claim 1, wherein the surface of the aluminum pigment C is coated with the two-layer film including the film containing acrylic resin and the film containing the phosphoric acid compound.

17. The chromate-free coated metal sheet according to claim 1, wherein the surface of the aluminum pigment C is coated with the film containing the phosphoric acid compound or silica.

18. The chromate-free coated metal sheet according to claim 1, wherein the surface of the aluminum pigment C is coated with the film containing the phosphoric acid compound or the two-layer film including the film containing acrylic resin and the film containing the phosphoric acid compound.

19. The chromate-free coated metal sheet according to claim 1, wherein the surface of the aluminum pigment C is coated with the film containing silica or the two-layer film including the film containing acrylic resin and the film containing the phosphoric acid compound.

20. The chromate-free coated metal sheet according to claim 1, wherein the surface of the aluminum pigment C is coated with the film containing the phosphoric acid compound or silica, or the two-layer film including the film containing acrylic resin and the film containing the phosphoric acid compound.

21. The chromate-free coated metal sheet according to claim 1, wherein the surface of the aluminum pigment C is coated with the film containing the molybdic acid compound or the film containing silica.

22. The chromate-free coated metal sheet according to claim 16, wherein the amount of the film containing acrylic resin is in a range of 8 to 20% by mass relative to 100% by mass of aluminum and the amount of the film containing the phosphoric acid compound is in a range of 0.2 to 2.0% by mass relative to 100% by mass of aluminum.
